(19) United States
(12) Patent Application Publication
(10) Pub. No.: US 2024/0236460 A9
(43) Pub. Date: Jul. 11, 2024

(54) METHOD AND SYSTEM FOR SINGLE-PIXEL IMAGING

(71) Applicant: INSTITUT NATIONAL DE LA RECHERCHE SCIENTIFIQUE, Québec (CA)

(72) Inventors: Patrick KILCULLEN, Montréal (CA); Jinyang LIANG, Boucherville (CA); Tsuneyuki OZAKI, Brossard (CA)

(21) Appl. No.: 18/492,974

(22) Filed: Oct. 24, 2023

Related U.S. Application Data
(60) Provisional application No. 63/380,620, filed on Oct. 24, 2022.

(51) Int. Cl. H04N 23/55

(52) U.S. Cl. CPC H04N 23/55

(57) ABSTRACT

A method and a system for single-pixel of an object is provided for deterministic two-dimensional (2D) spatial patterns onto the imaging beam, followed by data acquisition using a single-pixel detector. In the ensuing image reconstruction, these spatial patterns are used as prior knowledge to facilitate the accurate recovery of spatial information. By eliminating the need for a 2D sensor such as CCD or CMOS, the method and system allow using detectors whose cutting-edge performance or high specialization are impractical to manufacture in an array format. laser scanning rapidly deploys individual encoding masks as optically selected sub-regions larger aggregate patterns that are displayed via DMD. Pattern aggregation enhances SPI data acquisition rates to more than two orders of magnitude above the limitations of DMD-only modulation, while still retaining the frame size and flexibility of pattern display with DMDs. Meanwhile, a fast CS reconstruction algorithm, which is tightly coupled with the architecture of pattern deployment, is developed with full compatibility with parallel computing for real-time visualization.

### CROSS REFERENCE TO RELATED APPLICATIONS

This application claims benefit of U.S. provisional application Ser. No. 63/380,620, filed on Oct. 24, 2022. All documents above are incorporated herein in their entirety by reference.

### FIELD OF THE INVENTION

The present invention relates to single-pixel imaging. More precisely, the present invention is concerned with a method and a system for single-pixel imaging.

### BACKGROUND OF THE INVENTION

Single-pixel imaging (SPI) has been developed to allow multi-pixel images to be recorded using a single light sensing element, referred to as a detection pixel, as opposed to conventional imaging technologies such as complementary metal-oxide-semiconductor (CMOS) or charge-coupled device (CCD) sensors which use millions of independent detection pixels. In contrast, single-pixel systems use a sequence of encoding or modulation patterns to filter a scene along with the corresponding measurements of the total transmitted intensity which is recorded using a single-pixel detector. Within the wider context of computational imaging, this constraint reflects the technological limitations often encountered in many fields of scientific interest where construction of multi-pixel detectors may be prohibitively complex and/or expensive. By relaxing the requirement that data from different locations on an object must be collected at separate time instances, such as in imaging via point-by-point scanning for example, SPI aims at enabling imaging modalities lacking array detectors to benefit from improvements in speed and noise robustness while utilizing existing detector technology as-is.

In operation, an SPI system records data from a single sensing element while modulating an object imaging beam with a large number of deterministic spatial patterns. The measured single sensing element or pixel and the pre-determined modulation patterns are then used as inputs to reconstruction algorithms for recovering imagery of the object under examination. FIG. 1 shows a modulator 14 used to structure light collimated from a point source 12 to produce deterministic spatial patterns which illuminate the object 16. Light reflected from the object 16 and containing patterning from the modulator 14 and the object 16 is then sampled by a single detector element, which integrates the total reflected signal with the use of a condenser lens (detector 18). Example intensity cross sections show the result of beam interactions with the object in reflection. SPI data acquisition proceeds by the sequential display of different modulation patterns and the recording of associated detector measurements that together form the basis for subsequent step of image reconstruction using a computer.

There are still challenges in SPI, for (1) reduction in the time required for SPI measurement, (2) reduction in the time required for reconstruction and image recovery, and (3) enhancement of imaging resolution and quality in the context of challenges (1) and (2). In particular, a solution is desired which allows for the acquisition and display of high-resolution single-pixel imagery on a real-time basis, allowing for streaming single-pixel video. There is currently no method or system able to successfully address all three challenges simultaneously.

Methods for improving modulation speed currently center on the construction of custom illumination-only light emitting diode (LED) modules, or on masking pattern sets compatible with the sweeping of a continuous coded mask, which include modulation patterns produced mechanically as continuous coded perforations on fast rotating disks, and optically implemented sweeping of modulation patterns produced by spatial light modulators.

Reconstruction compatible with compressed sensing (CS), namely the recovery of acceptable image reconstructions from data of dimensionality less than that of the underlying image, frequently used to reduce the number of recorded modulations required for image recovery, thus decreasing the measurement overhead, although typically increasing the computational overhead required for data processing.

Current approaches for increasing the modulation rate of SPI are still limited by several drawbacks including device complexity, cost, difficulty of manufacturing, and the high-speed synchronization of multiple devices.

High-speed modulation via rotating mechanical masks does not allow reconfigurability, since the masking pattern sequence, in terms of its pattern construction, imaging resolution, and pattern ordering, cannot be altered. In addition, demands for high resolution invariably lead to difficulties in manufacturing which can increase cost, and exacerbate systematic errors such as track wobbling, which must be corrected, for example, with the use of a synchronized piezoelectric steering mirror incorporated into the optical setup.

Systems that incorporate galvanometers or resonant scanning mirrors are limited by mirror actuation speed and the complexity of motorization and control. In particular, the speed of galvanometers actuating a single mirror in an oscillatory motion, while dependent on the desired amplitude of the scan angle swept by the beam path, is typically limited to below 1 kHz in practice. Due to the constant acceleration and deceleration of the mirror, fast and robust operation requires the moment of inertia of the mirror be minimized by reducing the thickness and the size of the mirror. Although capable of higher actuation speeds, for example actuation speeds over 8 kHz, resonant scanning mirrors may only oscillate at fixed so-called resonant frequencies as determined by the characteristics of their construction. Moreover, the non-linear velocity profiles of such resonant scanning mirrors entails several technical overheads including the generation of control signals, synchronization, calibration of angular trajectories, and limited duty cycle available for high-speed pattern modulation due to the non-usability of the stationary turn around periods where the angular velocity of the oscillating mirror reaches zero.

In addition, compressive reconstruction methods typically operate in an iterative fashion, whereby the final image is obtained from the course of a series of approximations starting from an initial guess. In practice, the number of iterations required for satisfactory convergence is highly dependent on the underlying data and is thus unpredictable. As a result, decreases in measurement number and thus measurement time are typically achieved at the cost of proportionally larger increases in computational overhead for reconstruction. This displacement of time overhead from the acquisition phase to the reconstruction phase, although meeting the needs of a number of applications, has been a deterrent to works on SPI in real-time cases where time overheads of both acquisition and reconstruction must both be deterministic, and simultaneously reduced.

There is still a need in the art for a method and a system for single-pixel imaging.

### SUMMARY OF THE INVENTION

More specifically, in accordance with the present invention, there is provided a system for single-pixel imaging of an object, comprising a light source, a modulator, a polygonal mirror, a projector and a detector, the modulator generating structured patterns from an input beam generated by the light source, the polygonal mirror scanning the structured patterns, the projector projecting de-scanned structured patterns to the object, and the detector collecting signals from the object; and a parallelized-processing unit being selected for reconstruction of images of the object from the signals collected by the detector.

There is further provided a method for single-pixel imaging of an object, comprising generating encoding patterns by illuminating a modulator with an input beam, imparting a scanned motion to the encoding patterns by a polygonal mirror, projecting de-scanned encoding patterns to the object, detecting signals from the object, and reconstructing images of the object from the signals detected from the object by parallelized-processing.

There is further provided a method for single-pixel imaging of an object, comprising generating encoding patterns using a spatial light modulator, scanning the spatial light modulator and the encoding patterns by a polygonal mirror, projecting de-scanned encoded patterns to the object, detecting signals from the object under projection, and reconstructing images of the object from detected signals by parallelized-processing selected for images acquisition by a domain-specific matrix multiplication-based interpolation as determined by a sequence of the encoding patterns generated by the spatial light modulator.

There is further provided a system for single-pixel imaging of an object, comprising a light source, a modulator illuminated by the light source for generating encoding patterns, a polygonal mirror scanning the modulator and the encoding patterns, projection optics directing a resulting beam to the object, a detector collecting resulting signals from the object, and a parallelized-processing unit selected for images acquisition by a domain-specific matrix multiplication-based interpolation as determined by a sequence of the encoding patterns generated by the modulator for reconstruction of images of the object from the signals collected by the detector.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a schematic view of an SPI system of the prior art;

FIG. 2A is a schematic view of an SPI system according to an embodiment of an aspect of the present disclosure;

FIG. 2B is a schematical view of a double-scanning configuration according to an embodiment of an aspect of the present disclosure;

FIG. 2C is a closeup of an example aggregate masking pattern in a sequence suitable for 41×43 pixel resolution imaging;

FIG. 2D is a schematic view of a single-scanning configuration according to an embodiment of an aspect of the present disclosure;

FIG. 3A shows a binary cyclic S-matrix of order n=35 (i.e., p=7 rows and q=5 columns); green dotted-line boxes (also appearing in FIG. 3B and FIG. 3C) highlight the role of a single encoding pattern, blue dashed-line boxes (also appearing in FIG. 3B and FIG. 3C) highlight a range of p rows deployed together in each scan;

FIG. 3B shows a restructured matrix pattern formed from the matrix shown FIG. 3A; the numbers representing the corresponding column indices of each element of the first row of the matrix shown in FIG. 3A, with shaded colors highlighting four tiled copies of the reshaped initial row; a blue dashed-line box showing an aggregate pattern displayed via a digital micromirror device (DMD); a green dotted-line box showing a single encoding pattern (corresponding to row 17) also highlighted in FIG. 3A;

FIG. 3C shows arrangement of the bucket signals as a 2D array with numbers corresponding to row indices of the matrix in FIG. 3A; a green dotted-line box highlighting the role of the single encoding pattern highlighted in FIG. 3B; light blue shading highlighting an expected neighbourhood of similar values surrounding the measurement from the encoding pattern; a blue dashed-line box showing a row of bucket signals acquired from the deployment of the aggregate pattern similarly highlighted in FIG. 3B;

FIG. 4A is a photograph of position ruler and illuminated field of view (FOV) of 10 mm×10 mm;

FIG. 4B shows selected frames from a single-pixel video reconstructed with 100% sampling at 144 fps;

FIG. 4C shows selected frames from a single-pixel video reconstructed with 50% sampling at 298 fps;

FIG. 4D shows selected frames from a single-pixel video reconstructed with 25% sampling at 598 fps;

FIG. 4E shows normalized average intensity profiles from a selected region with a size of 5×43 pixels (marked by boxes in FIG. 4B-FIG. 4D), compared to ground truth;

FIG. 5A is a photo of the internal components, e. movement of a mechanical watch;

FIG. 5B shows selected frames from a single-pixel video of the running mechanical watch movement reconstructed with 50% sampling at 103 fps;

FIG. 5C shows time evolution of the intensity of three selected pixels marked in the expanded inset of FIG. 5B, illustrating the dynamics of two components of the watch movement, consisting of the approximate 2.5 Hz motion of the balance wheel and the 5.0 Hz intermittent motion of the escape wheel; thicker lines in different styles showing moving averages (7-frame window) with raw data shown by the thin solid lines;

FIG. 5D shows a setup for imaging the rupture of a popcorn kernel;

FIG. 5E shows selected frames of the rupture reconstructed at 298 fps with 50% sampling;

FIG. 5F shows traced outlines of the kernel from selected frames showing its expansion during rupture;

FIG. 6A is a photo of an unmodified incandescent light bulb showing an enclosed filament;

FIG. 6B shows selected frames of a single-pixel video of the burn out of the unmodified bulb's filament reconstructed at 298 fps with 50% sampling;

FIG. 6C shows the time evolution of the intensity of a background region (8×8 pixels) highlighted in FIG. 6B; the thick line shows the moving average (21-frame window) with raw data shown by the thin line;

FIG. 6D is a photo of a modified bulb with the filament directly exposed to air;

FIG. 6E shows selected frames of a single-pixel video of the burn out of the modified bulb reconstructed at 298 fps with 50% sampling;

FIG. 6F shows time evolution of the intensity of a background region (8×8 pixels) highlighted in FIG. 6E; the thick line shows the moving average (21-frame window) with raw data shown by the thin line;

FIG. 7A is a schematical view of an experimental setup wherein the object was a slotted wheel rotating at 4800 revolutions per minute (RPM); various color boxes showing the different regions imaged by SPI accelerated via swept aggregate patterns (SPI-ASAP);

FIG. 7B, FIG. 7C. FIG. 7D. FIG. 7E, FIG. 7F show consecutive frames of ultrahigh-speed single-pixel videos reconstructed at 12,000 fps with 55% sampling, with outline colors corresponding to the FOV positions shown in FIG. 7A;

FIG. 7G shows time history of normalized intensity for a selected pixel, marked by a point in FIG. 7B;

FIG. 8A is a scale illustration of SPI-ASAP system components, with four beam paths highlighting the scanning action shown by the colors orange, blue, red, and green, in the order of appearance during scanning;

FIG. 8B is a closeup showing the positions of lenses for beam scanning and de-scanning;

FIG. 9A is a closeup of polygonal mirror reflections showing the correlation of beam angle for scanning and de-scanning, arrows indicating directions of polygonal mirror rotation and the direction of propagation of the laser beams;

FIG. 9B is a closeup of the DMD surface showing the effect of diffraction angle on lateral beam translation distances, arrows indicating directions of illumination scanning and the laser beams' propagation direction.

FIG. 10A is a block diagram illustrating the paths of signals involved in timing and acquisition;

FIG. 10B is a schematic timing diagram illustrating synchronization and data registration; inserts (i) thru (iv) show the initial frames of a DMD sequence for 41×43-pixel resolution imaging, consisting of (i) a blank frame, (ii) the initial encoding pattern region, (iii) the final encoding pattern region, and (iv) the first aggregate pattern;

FIG. 11A shows reconstruction quality evaluated by peak signal-to-noise ratio (PSNR) for SPI-ASAP compared with reconstruction methods MinTV and MinDCT;

FIG. 11B shows reconstruction quality evaluated by structural similarity index (SSIM) for SPI-ASAP compared with MinTV and MinDCT;

FIG. 11C shows the running time for SPI-ASAP, MinTV, and MinDCT plotted as a function of sampling rate; the vertical axis in FIG. 11 C is discontinuous in order to show details in the timing data of SPI-ASAP that are much smaller than that of the compared methods;

FIG. 11D shows a visual comparison of a subset of reconstructed images, with the ground truth “Cameraman” image displayed with a frame size of 59×61 pixels;

FIG. 12 is a schematic view of a system for the imaging of incandescent filaments suitable for environments with high ambient light interference according to an embodiment of an aspect of the present disclosure;

FIG. 13A shows a multi-aggregate pattern scheme for 11×13-pixel resolution imaging consisting of six joint aggregate patterns distinguished by the various shaded colors;

FIG. 13B is a schematic timing diagram illustrating synchronization and data registration for the multi-aggregate pattern scheme; example waveforms corresponding to the display of initial (i) and final (ii) sub-regions on the mask, as well as (iii) the static multi-aggregate pattern;

FIG. 14A shows averaged reconstructed images and normalized intensity profiles of a resolution target (1951 USAF) rotated through angles of 0°, 30°, 60°, 90°, with profiles 1-3 corresponding to the vertical line pairs of Group 1 Elements 2-4, respectively; error bars show one standard deviation;

FIG. 14B shows averaged reconstructed images and normalized intensity profiles of a resolution target (1951 USAF) rotated through angles of 0°, 30°, 60°, 90° and profiles 1-3 corresponding to the vertical line pairs of Group 2 Elements 3-5, respectively; error bars show one standard deviation;

FIG. 15 shows the parameters for cubic spline interpolation according to an embodiment of an aspect of the present disclosure;

FIG. 16 is a table of performance comparisons of a method according to an embodiment of an aspect of the present disclosure with prior art methods; and

FIG. 17 is a table summarizing parameters used to determine the sequencing of aggregate patterns, according to an embodiment of an aspect of the present disclosure.

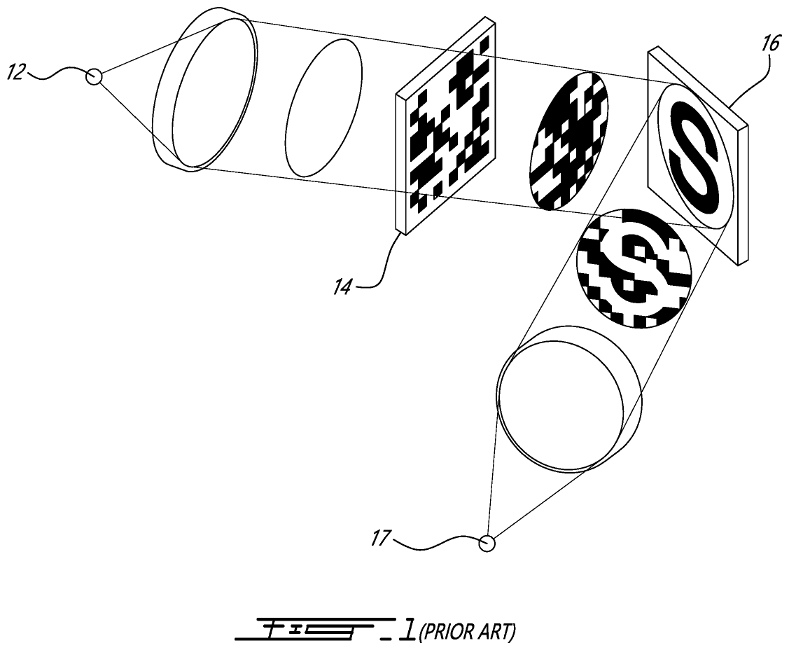

### DESCRIPTION OF ILLUSTRATIVE EMBODIMENTS

The present invention is illustrated in further details by the following non-limiting examples.

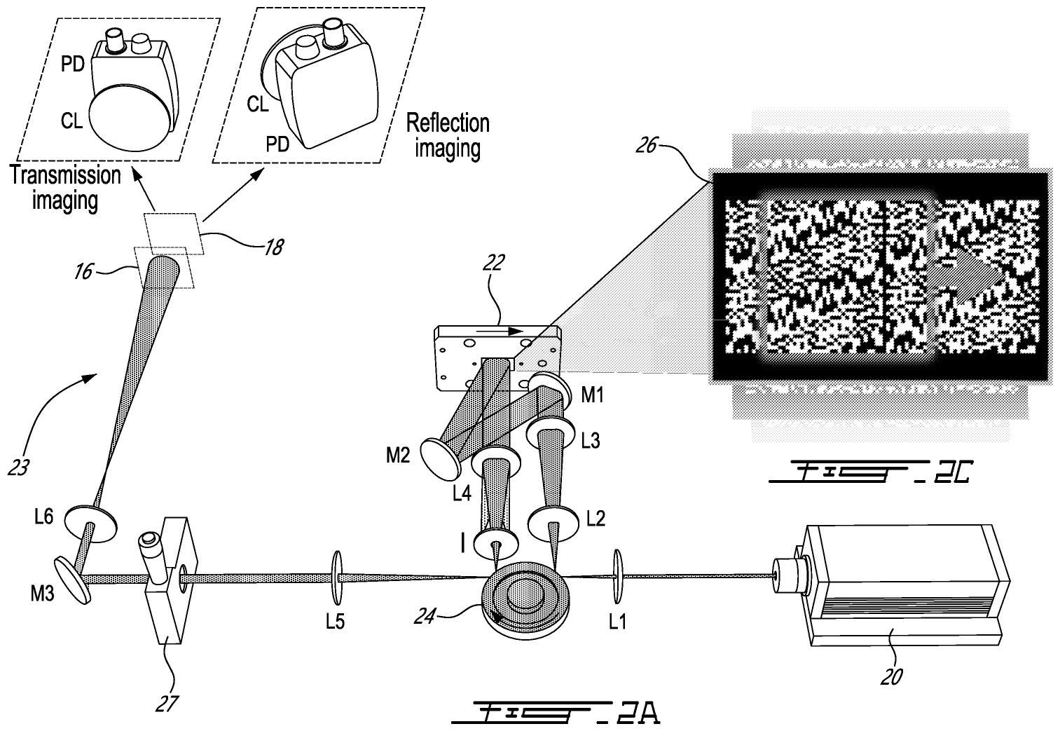

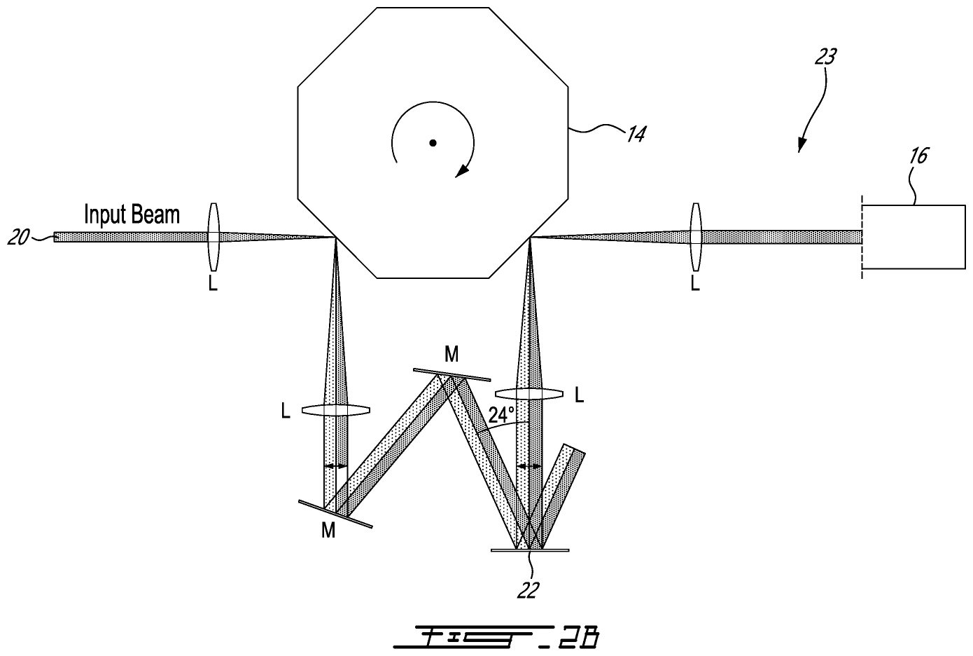

In an embodiment of a system according to an embodiment of an aspect of the present disclosure as illustrated for example in FIG. 2A, an input beam from a laser 20 is structured by an encoding pattern using a modulator 22 such as a DMD, the DMD-displayed aggregate pattern 26 is scanned by rotation of a polygonal mirror 24 and the de-scanned beam is projected onto the object 16, using projection optics 23; the image of the object 16 is transmitted by a detector 18 for either transmission imaging or reflection imaging (condenser lens CL and photodiode PD in FIG. 2A). Arrows indicate the rotation direction of the polygonal mirror 24 of and of the illumination scanning. The number of facets of the polygonal mirror 24 shown is illustrative only, and may be increased, and the direction of rotation shown by the arrow may be reversed. FIG. 2A shows transmission imaging (28) and reflection imaging (29). FIG. 2B is a schematical view of double-scanning in FIG. 2A. FIG. 2C shows a representative encoding pattern 26, the optical scanning direction being indicated by an arrow.

Thus, the DMD and the polygonal scanning mirror are connected for an optical interaction therebetween such that optical sweeping of the DMD illumination and encoding patterns is produced; for the scanned illumination, a reflection configuration or a transmission configuration may be selected.

Single-scanning according to an embodiment is illustrated in FIG. 2D. In double-scanning according to an embodiment illustrated in FIG. 2B-2C the beam is reflected twice from the polygonal mirror 24, resulting in a double scan producing swept illumination on the surface of the DMD 22 and stabilization of the resulting patterned beam for projection towards the object 16 and the detector 18.

Acquisition times are reduced by increasing modulation rates by allowing for the deployment of multiple masking patterns, in a range between 50 and 100 for example, from a single DMD-displayed pattern, thus allowing for the acquisition rate to exceed the limitation imposed by the baseline DMD refresh rate (6.37 kHz for a AJD-4500, by Ajile Light Industries for example, up to 32 kHz for state of the art devices), by up to three orders of magnitude.

The system and method allows simultaneous reduction of acquisition and reconstruction times, and the recovery of images with flexible resolutions of up to several thousand pixels; in experiments described hereinbelow in the ANNEX, total pixel counts in reconstructed images ranged roughly from 100 to 10,000. This is limited by the pixel count available on the DMD, as well as the optical bandwidth, i.e. resolution, of the system.

Selecting polygonal mirror scanning, as illustrated in FIG. 2 increases the flexibility and performance of digital micromirror devices for SPI and simultaneously improves upon several limitations of galvanometer and resonant scanning mirror-based SPI systems and methods, as follows, for example: simultaneously deflection of two separate mirror facets in the same mirror overcomes the need for the synchronization of multiple separate mirror reflectors; motorization is simplified since the angular speed of the facets on the polygon mirror remains constant, allowing scan rates of many-faceted polygons to reach above 10 kHz; scan rates may be continuously varied with the rotational speed of the motor of the polygon mirror, thus increasing flexibility over resonant scanning mirrors of fixed period of oscillation; due to the linear time dependence of the scan angle for polygonal mirrors, there is no need for precise calibration of control signals; selecting polygonal mirrors, by eliminating the deceleration period required by galvanometers and resonant scanning mirrors, allows increasing scan duty cycles and the scan duty cycles may be optimized by selecting facet count.

A coding method and a reconstruction method using cyclic S-matrices are selected for generating the modulation pattern, resulting in a fast image recovery based on matrix multiplication, as further described hereinbelow in the ANNEX. Furthermore, compressive sensing is supported by taking advantage of expected 2D-smoothness redundancy in the acquired measurements, allowing for the estimation of non-actualized measurement values by interpolation. Both the interpolation and image recovery steps of the reconstruction are selected for non-iterative implementations compatible with graphics processing unit (GPU)-parallelization, thus reducing reconstruction times and achieving real-time SPI.

Scanning of the DMD patterns by a polygonal mirror is done in a single-scanning configuration (see FIG. 2D) or in a double scanning configuration (see FIGS. 2A-C), and a GPU-based non-iterative reconstruction method is selected for compressed sensing. Real-time operation is achieved with GPU-compatible software developed for reconstruction and display, and a domain-specific matrix multiplication-based interpolation selected for massively parallelized computation on GPU hardware. The present method and system are fully compatible with off-line reconstruction for applications in high-speed SPI. Moreover, the combination of the use of a polygonal scanning mirror and GPU-based non-iterative reconstruction allows SPI with flexible real-time high-resolution operation, thereby improving SPI as a framework for the development of fast and user-friendly imaging systems of commercial interest, enhancing the speed and robustness of existing imaging systems lacking multi-pixel detectors.

The present modulation acceleration method allows pattern projection rates of up to 14.1 MHz (see in experiments described in the ANNEX hereinbelow, featuring modulation rates ranging between 3.0 MHz and 14.1 MHz), allowing, for example, real-time SPI at 96 fps with a resolution of 101×103 pixels. Framerate and resolution may be flexibly altered in order to increase one while typically sacrificing the other. In practice, real-time operation over 100 fps produces no benefit due to finite human reaction times and limitations of most personal computers operating system software and displays. Thus, a range of target framerates may range from 0 Hz to 100 Hz. Resolution is conceptually limited by optics and the DMD's mirror count. In experiments, the optics were the limiting factor, giving 101×103 pixels. If DMD resolution were the limit, resolutions of roughly 500×500 would be achievable, corresponding roughly to an aggregate pattern with a width of 1000 pixels, a typical pixel count limit of DMDs. In experiments presented in the ANNEX hereinbelow, the lowest resolution was 11×13pixels. Thus, the present modulation acceleration method bypasses the speed restriction of DMDs in SPI and may serve as a building block for real-time high speed SPI systems, using simple optics, such as lenses or concave mirrors, and mirrors, for applications not only in the visible range but also in non-visible ranges, including sound and other physical phenomena of interest where conventional multi-pixel image sensors do not apply.

The digital micromirror device that generates encoding patterns may have a display area larger than 5 mm×5 mm, display pixel-count larger than 10×10 pixels, and display refresh rate larger than 6 kHz; alternatively, reconfigurable display, such as liquid crystal displays, and non-reconfigurable physical masks may be used. The polygonal scanning mirror may be selected with a facet count larger than 4, facet size, larger than 2 mm×2 mm, and scan rate larger than 6 kHz. Scanning illumination of the DMD may be done in the double-scanning configuration (FIGS. 2A-2C) or in a single-scanning configuration as schematically shown in FIG. 2D.

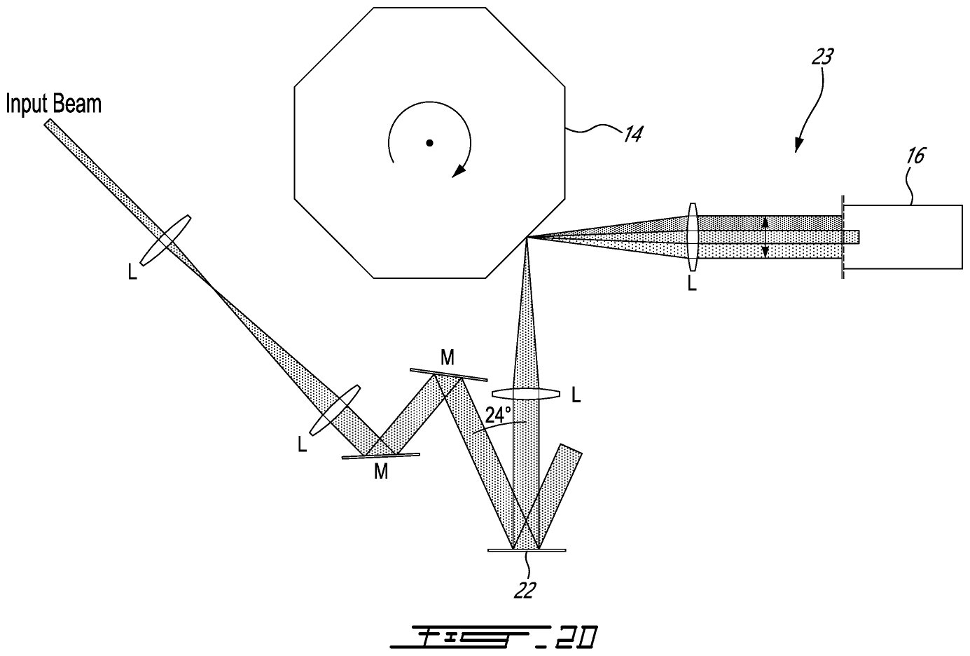

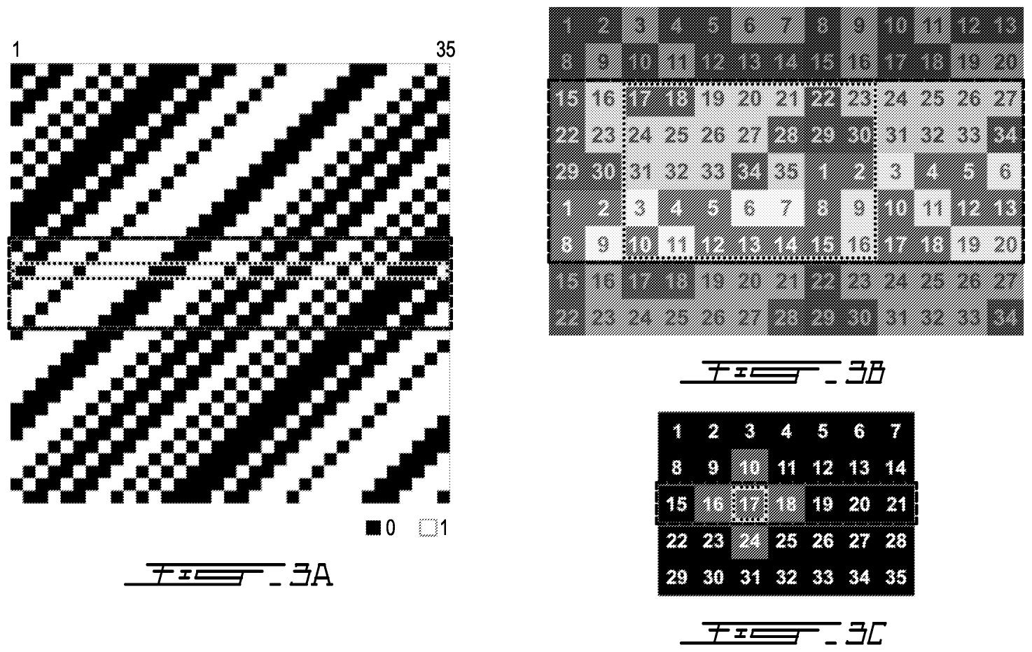

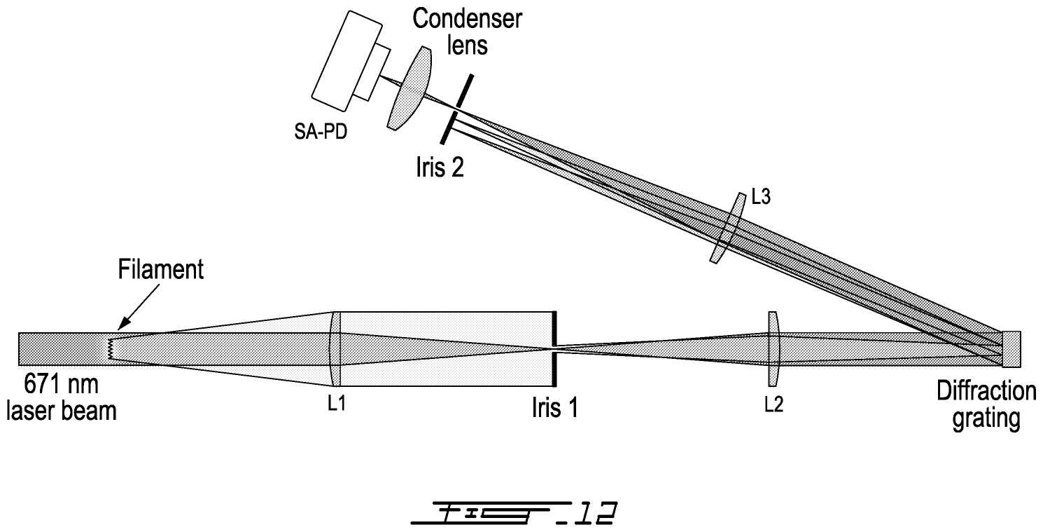

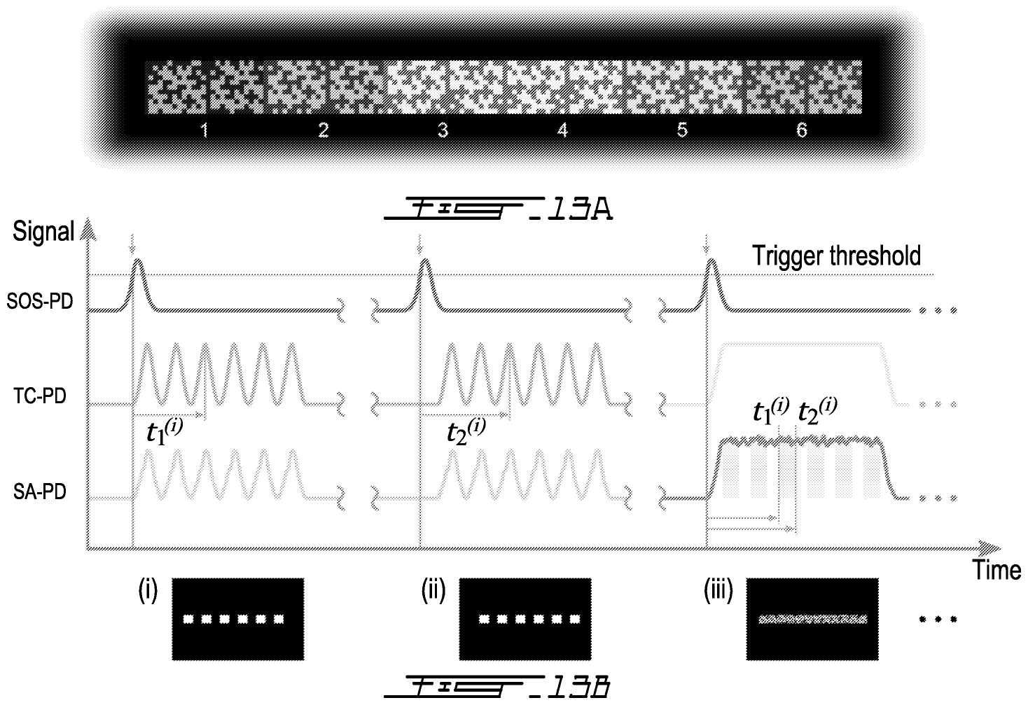

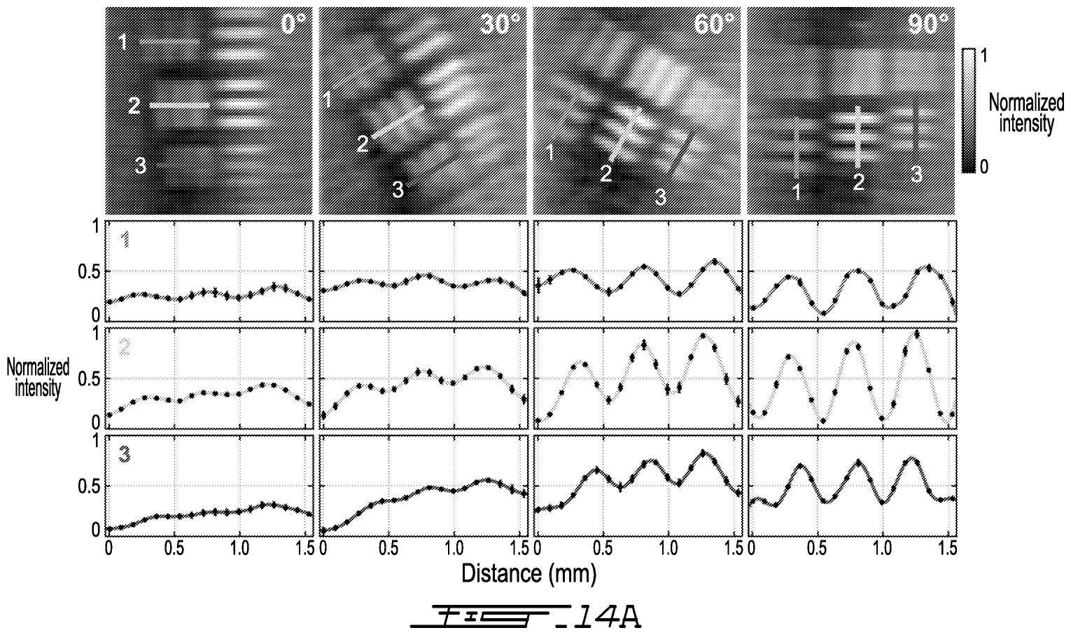

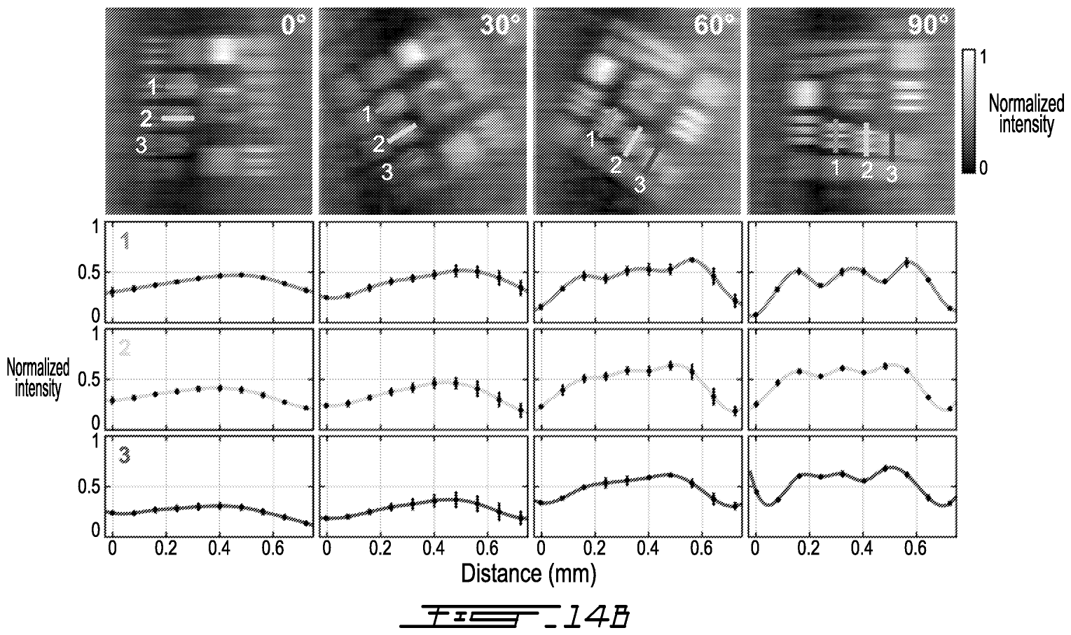

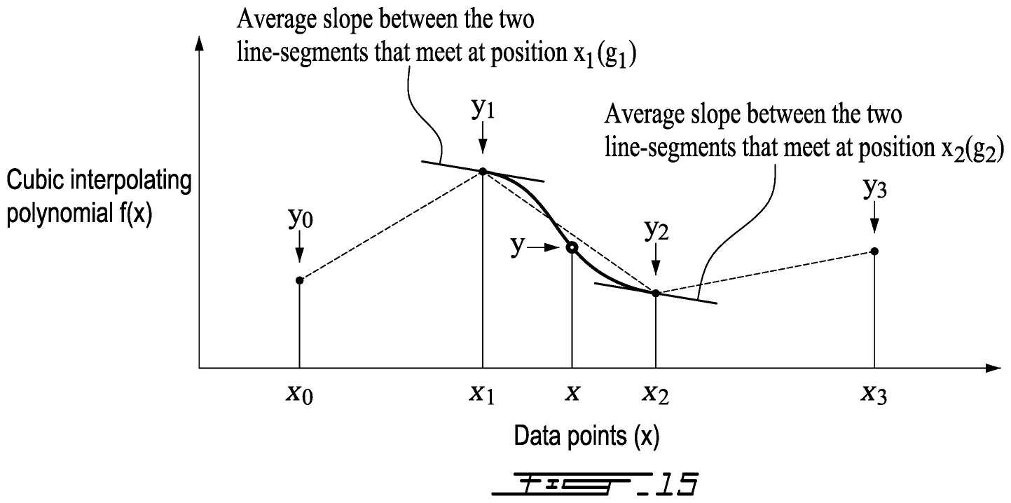

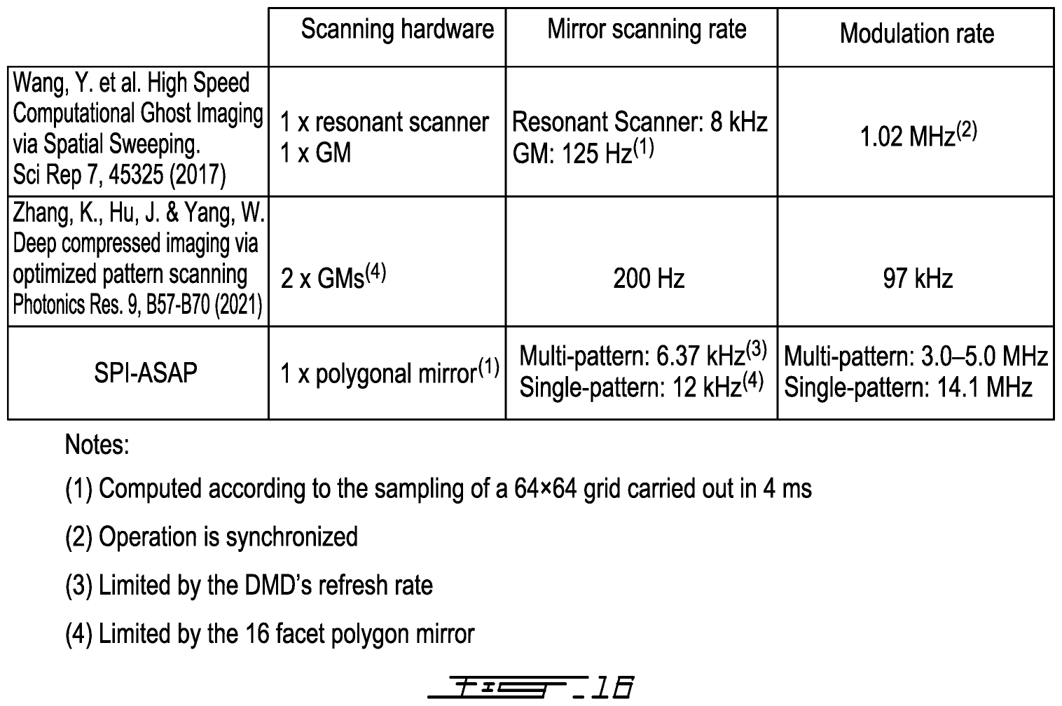

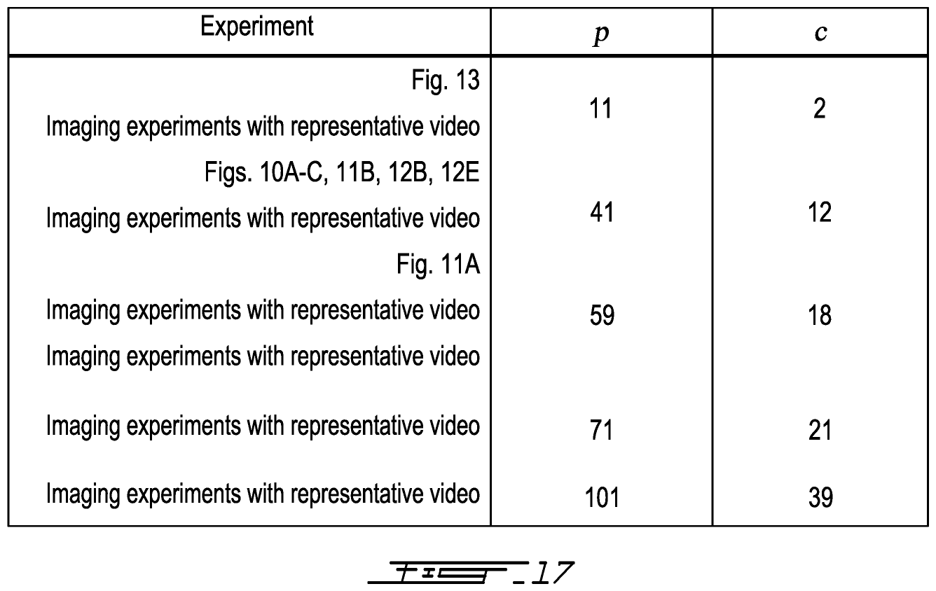

The sampling rate for digitization of the input photodiode signals and storage in host computer memory (FIG. 10) may be higher than 20 MHz with bandwidth larger than 10 MHz; transfer of the digitized photodiode signal data from the host computer memory to a GPU device and of the output recovered image data from the GPU device to the host computer memory may be achieved at a transfer rate larger than 1.0 GB/s (1.6 GB/s via PCIe x8 is used in the experiments described herein). Image data recovery comprises the steps: (1) two-dimensional interpolation of the input photodiode signal data by matrix-matrix multiplication (FIG. 3) that accomplishes compensation for possible reduced dimensionality of the input signals as compared to dimensionality of the output data, (i.e., the recovered images) and possibly also noise filtering, and (2) application of the inverse cyclic S-matrix transform defined by the sequence of encoding patterns displayed by the DMD during the acquisition of data. The recovered image data may be displayed on a graphical screen or recorded in a digital format.

### Annex

In experiments of SPI accelerated via swept aggregate patterns (SPI-ASAP) described hereinbelow pattern projection rates of up to 14.1 MHz are achieved, by combining a digital micromirror device with laser scanning hardware. Meanwhile, leveraging the structural properties of S-cyclic matrices, a lightweight compressed sensing reconstruction algorithm, fully compatible with parallel computing, is developed for real-time video streaming at 96 frames per second (fps). SPI-ASAP is shown to allow reconfigurable imaging in both transmission and reflection modes, dynamic imaging under strong ambient light, and offline ultrahigh-speed imaging at speeds of 12,000 fps, depending on many factors, including polygonal mirror speed and DMD pixel count.

As people in the art will appreciate, limitations of SPI related to the refresh rates of digital micromirror devices and time-consuming iterations in compressed-sensing (CS)-based reconstruction, as well as the use of fast-moving mechanical masks are herein addressed, and reconfigurability and/or accuracy increased. The approach described herein imparts deterministic two-dimensional (2D) spatial patterns onto the imaging beam, followed by data acquisition using a single-pixel detector. In the ensuing image reconstruction, these spatial patterns are used as prior knowledge to facilitate the accurate recovery of spatial information. By eliminating the need for a 2D sensor such as CCD or CMOS, the method and system allow using detectors whose cutting-edge performance or high specialization are impractical to manufacture in an array format. For example, SPI paired with photomultiplier tubes may be used for time-of-flight three-dimensional (3D) profilometry, single-photon imaging, and imaging of objects hidden from direct line-of-sight. SPI combined with electro-optic detection may be used in terahertz (THz) imaging. SPI implemented with ultrasonic transducers has found applications in photoacoustic imaging.

As disclosed herein, the implementation of laser scanning rapidly deploys individual encoding masks as optically selected sub-regions larger aggregate patterns that are displayed via DMD. In this way, pattern aggregation enhances SPI data acquisition rates to more than two orders of magnitude above the limitations of DMD-only modulation, while still retaining the frame size and flexibility of pattern display with DMDs. Meanwhile, a fast CS reconstruction algorithm, which is tightly coupled with the architecture of pattern deployment, is developed with full compatibility with parallel computing for real-time visualization. Altogether, SPI-ASAP projects encoding patterns at a rate of up to 14.1 MHz, allowing for reconfigurable 2D imaging offline at up to 12 thousand frames per second (kfps). Unrestricted by the iterative optimization of conventional CS-based image reconstruction, SPI-ASAP empowers real-time video operation at 96 fps for frame sizes of up to 101×103 pixels.

A SPI-ASAP system in a double-scanning configuration as experimented herein is schematically shown in FIGS. 2A-2C. A 200 mW continuous-wave laser operating at 671 nm is used as the light source. The ultrahigh-speed pattern sweeping is generated by a 16-facet polygonal mirror, a 0.45″ DMD, and associated optical components (L are condenser lenses, and M are mirrors). The incident beam is first reflected by a facet of the polygonal mirror, which creates illumination that rapidly moves across the DMD surface at a 24° angle of incidence. Binary patterns, represented numerically as {0,1}-valued 2D arrays, are displayed on this DMD. Containing an array of 912×1140 square micromirrors (7.6 μm pitch), the DMD uses tilt actuation to either discard the beam (via the 0-valued pixels) or reflect it (via the 1-valued pixels) back to the polygonal mirror. An iris, positioned near the back focal plane of L4, selects the strongest diffraction order. Owing to the symmetry of the optical path, the second reflection by the polygonal mirror imparts an equal and opposite scanning motion to the imaging beam, which stabilizes its position at an adjustable slit 27. Meanwhile, because this slit 27 receives an image of the illuminated part of the DMD's surface, stabilization by the second reflection also imparts a rapid scanning motion to the patterns that tracks with the motion of the scanned illumination. Dual-scanning increases the optical efficiency of SPI-ASAP over single-scanning design because illumination is concentrated on only the parts of the DMD surface that are conveyed to the adjustable slit 27.

During operation, each scan induced by a polygonal mirror facet is synchronized with the display of a new aggregate binary pattern pre-stored by the DMD. After transmitting through the slit, the structured illumination interrogates the structure of objects placed in the image plane (imaged by lens L6). A portion of light transmitted or reflected by an object is focused by a condenser lens to a photodiode that is positioned to receive light in either the transmission mode or the reflection mode (see (FIG. 2A). The recorded data points, referred to as bucket signals, are transferred to a computer for ensuing image processing. The full details of the experimental setup, principles of laser beam encoding and de-scanning, as well as system synchronization, are discussed hereinbelow (see Methods and Supplementary Notes 1 and 2). A discussion of polygonal mirror scanning in SPI-ASAP is provided hereinbelow in Supplementary Note 3.

### Coding Method and Image Recovery

The bucket signals, denoted by an m-element vector y, can be regarded as the optically computed inner products between an n-pixel image x and the set of encoding patterns {sᵢ, i=1 . . . m}. This process can be expressed in the form of a single m by n matrix relation as follows:

y=Sx. (1)

The measurement matrix S contains each encoding pattern written in row form and corresponding to the order of the bucket signals in y. SPI-ASAP uses cyclic S-matrices to generate encoding patterns, with FIG. 3A illustrating an example for n=35. Individual encoding patterns arise from the 2D reshaping of the rows of S by row-major ordering. Writing n=pq for the dimensions of the reshaped rows, it is possible to restructure the information in S to form a (2p−1)×(2q−1) pattern that exactly encompasses all 2D encoding patterns determined by its rows. An example of such restructuring is shown in FIG. 3B, from which it can be seen that each p×q sub-region represents a 2D reshaped row of S, with the corresponding row index appearing as the number in the top leftmost corner element. In each scan, a p×(2q−1) sub-region of the restructured matrix pattern displays on the DMD. The scanning action of the optical system then sequentially illuminates and projects each p×q sub-area of this pattern, resulting in the deployment of q encoding patterns (see an example in FIG. 3B). This process then repeats, each time using a different p×(2q−1) sub-region of the restructured matrix pattern to aggregate the deployment of q encoding patterns in each scan. After p scans, a full measurement is completed when the DMD-displayed aggregate patterns traverse through the entire restructured matrix pattern. More details of cyclic S-matrices are discussed hereinbelow (see Methods).

Owning to the 2D packing relationship of the encoding patterns within the restructured matrix pattern, their deployment in SPI-ASAP can be regarded as an operation of 2D discrete convolution on the (2p−1)×(2q−1) restructured matrix pattern, with the underlying image used as a kernel of size p×q. Thus, because of the high similarity in the structures of spatially adjacent encoding patterns, the bucket signals y exhibit 2D smoothness when reshaped to a matrix Y of the same size as the image (FIG. 3C). Moreover, periodic boundary conditions are exhibited by Y, allowing 2D smoothness to extend to all elements. Therefore, in general, a bucket signal indexed to row i of S will exhibit a high similarity with the bucket signals that surround it in Y, with the four nearest neighbouring bucket signals in particular corresponding to the rows i−1, i+1, i−q, and i+q in S, with q denoting the width of the reshaped rows and indices interpreted modulo n.

This property motivates a method to incorporate CS, i.e., m<n, in rapid image recovery. By using carefully selected encoding patterns, a set of evenly distributed samples is selected on Y. Then, the values of non-sampled elements can be estimated by interpolation, which empowers image recovery by direct inversion of relation (1) hereinabove. The architecture of SPI-ASAP enables a particular sampling method in which bucket signals corresponding to complete rows of Y are acquired in each scan. Aggregate patterns are thus formed in the manner shown by the blue boxes in FIGS. 3, with the displayed DMD pattern sequence determined by an evenly distributed selection of rows from Y.

In this case of row-wise subsampling, non-sampled data in Y can be approximated by one-dimensional (1D) interpolation along columns with a method such as spline interpolation. This operation, along with optional low-pass filtering, can be implemented using only matrix multiplication with the assistance of pre-computed elements. Thus, SPI-ASAP's reconstruction algorithm is compatible with the architecture of a GPU for real-time visualization. Meanwhile, by sectioning streams of bucket signals generated by continuous scanning, videos can be reconstructed with tunable frame rates. Details regarding the sequencing of aggregate patterns, data segmentation for video reconstruction, determination of imaging speeds, and implementation of image reconstruction using matrix multiplication are provided in Methods. Simulated comparisons of SPI-ASAP to existing CS-based reconstruction algorithms are provided in Supplementary Note 4 hereinbelow. The results of this comparison (see FIG. 11) show that SPI-ASAP accelerates reconstruction speeds by 2-3 orders of magnitude while maintaining comparable or superior reconstructed image quality. In the comparison of image reconstruction between SPI-ASAP and two widely used CS algorithms of FIG. 11, the ground truth is the “Cameraman” image with a frame size of 59×61 pixels.

### Demonstration of SPI-ASAP in Transmission Mode

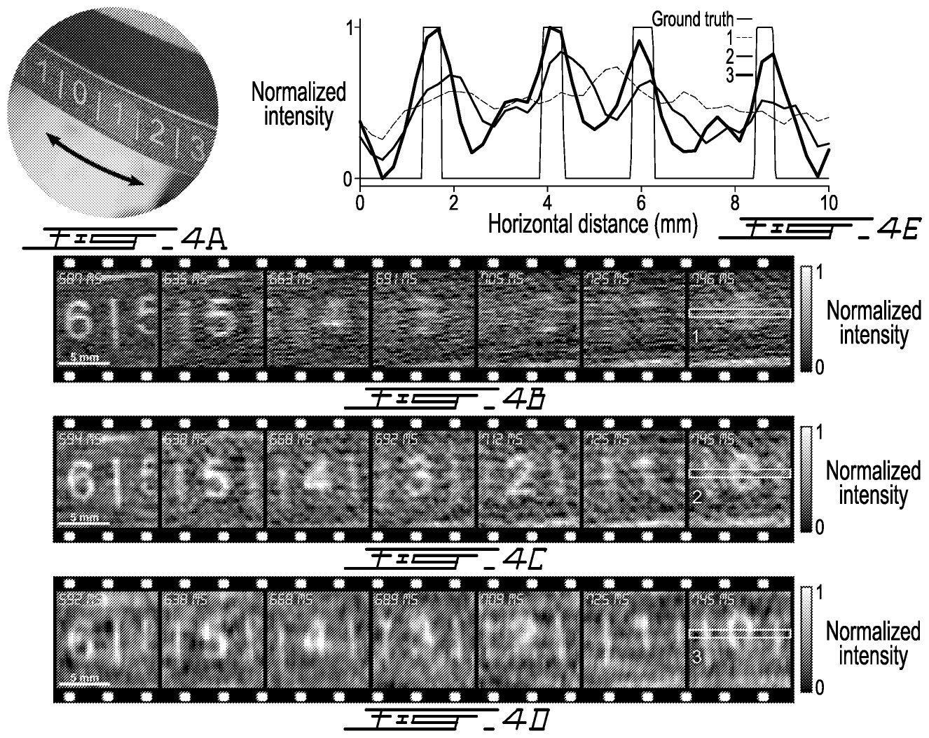

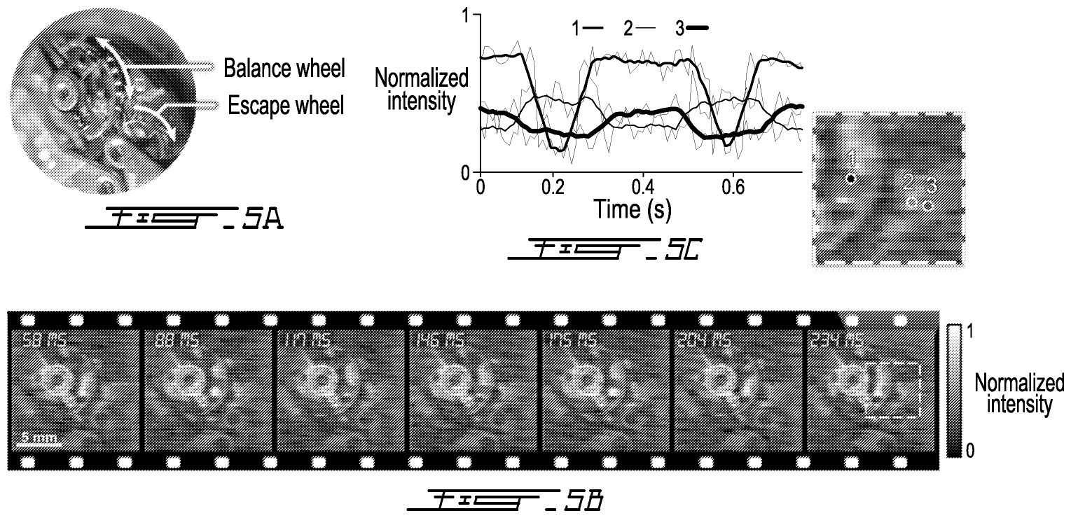

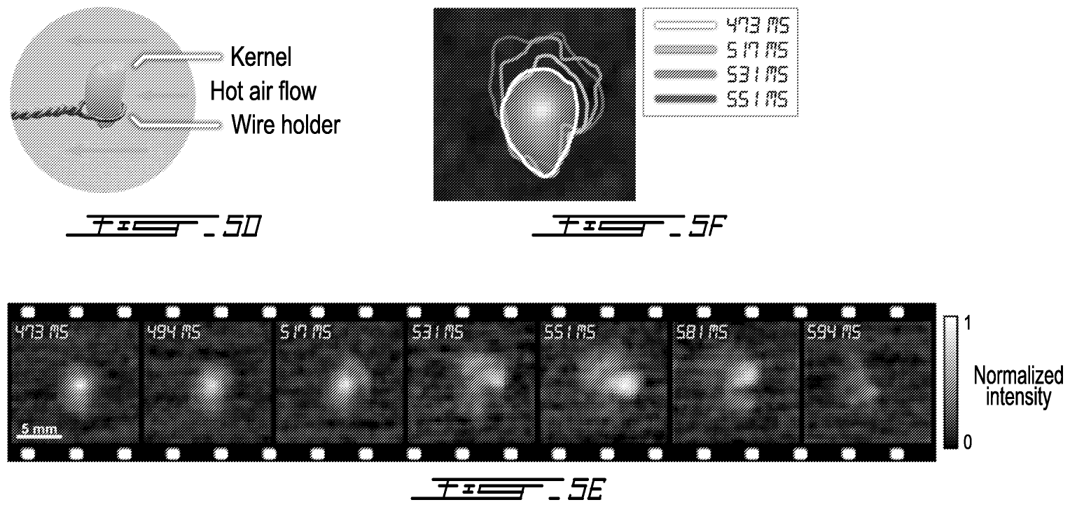

The dampened oscillations of a pendulum object with a 10-cm radius is imaged. As shown in FIGS 4, on the bottom of this pendulum is a scale consisting of the digits “0” to “9” separated by vertical lines. “0” is placed at the pendulum's rest position, and the remaining digits are placed symmetrically at increasing distances. Working in transmission mode, the SPI-ASAP system had a frame size of 41×43 pixels (n=1,763), corresponding to a field-of-view (FOV) of approximately 10 mm×10 mm.

The motion of the pendulum was recorded over 1.54 seconds during which the pendulum exhibited dampened oscillations and came to rest at equilibrium. FIGS. 4B-4D show representative frames from each reconstructed video of three videos reconstructed from this dataset corresponding to sampling rates of 100%, 50%, and 25%, with imaging speeds of 144 fps, 298 fps, and 598 fps, respectively. Unlike conventional imaging for which fast-moving objects may exhibit only localized motion blurring, the sequential and wide-field nature of SPI's data acquisition produces global artifacts for highly dynamic scenes. As illustrated by the profiles compared in FIG. 4E, increased frame rates by CS-assisted SPI-ASAP reduce these blur artifacts, allowing details of fast-moving objects to be resolved. Attractively, this flexibility is controlled entirely at the reconstruction stage, thus allowing a balance between overall image quality and frame rate to be optimized to suit specific datasets.

### Demonstration of SPI-ASAP in Reflection Mode

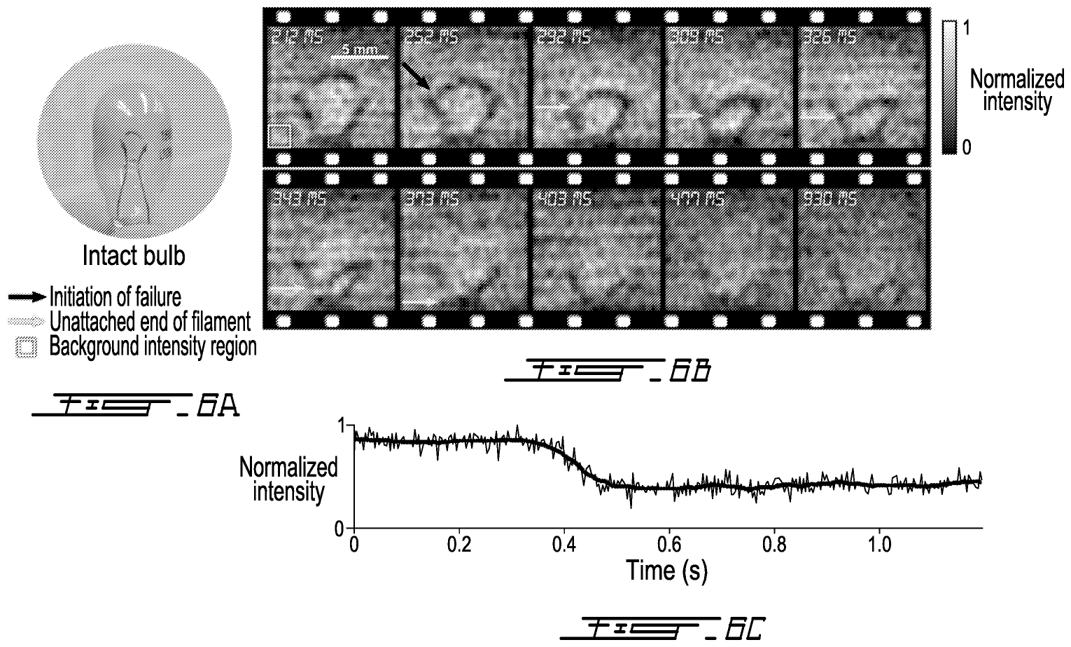

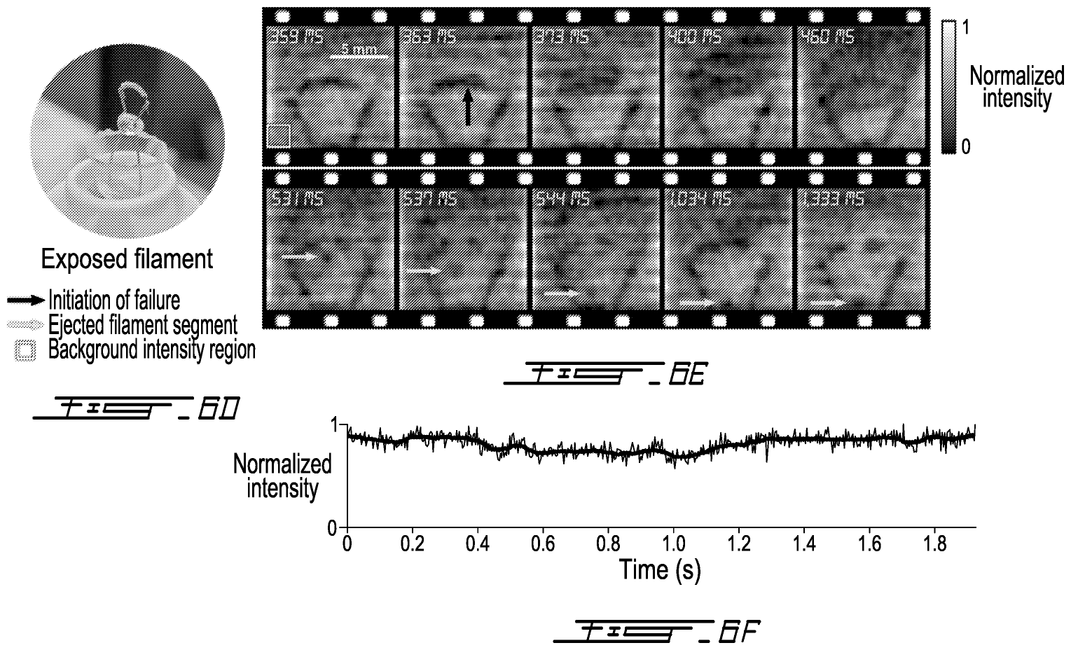

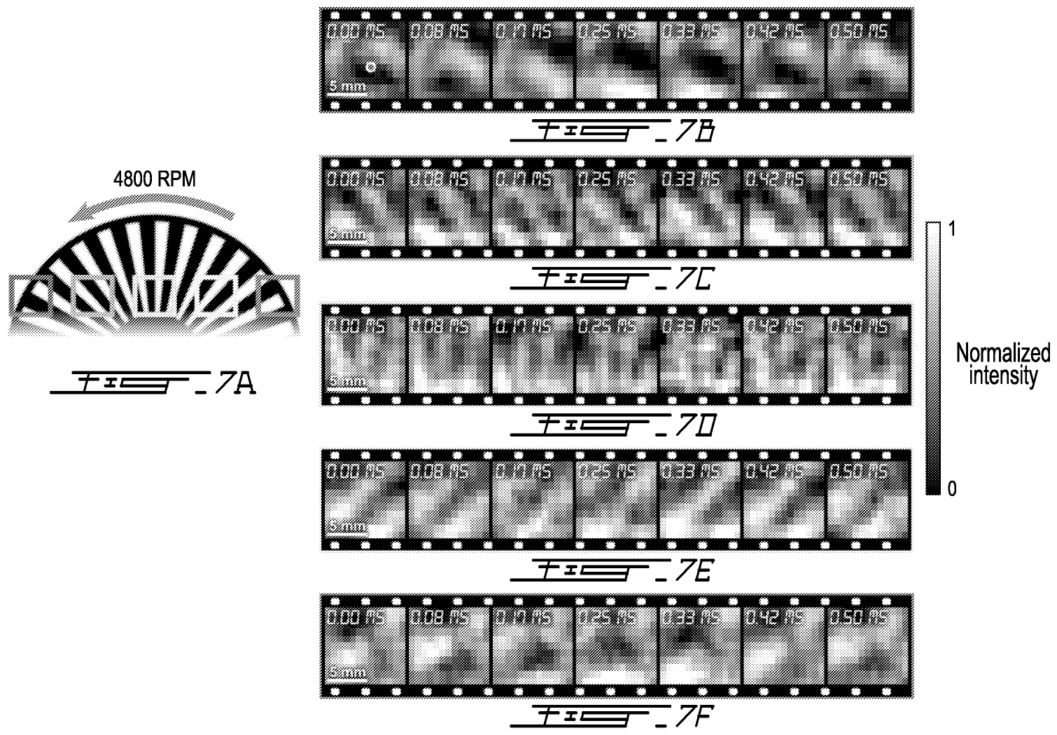

To test the SPI-ASAP system in reflection mode, the internal components of a running mechanical watch movement is imaged (FIG. 5A). The balance wheel, which controlled the intermittent motion of the escape wheel, underwent sustained oscillatory motion at approximately 2.5 Hz. The SPI-ASAP system had a FOV of 14 mm x 14 mm, a frame size of 59×61 pixels, and an imaging speed of 103 fps (with 100% sampling). FIG. 5B illustrates selected frames from the reconstructed videos. Intensity data from three pixels are plotted in FIG. 5C to study the motion of the internal wheels. Pixel 1 selects a position that is darkened once per full oscillation of the balance wheel and thus allows for quantification of the 2.5 Hz oscillation frequency. Pixels 2 and 3 select positions that are alternatively darkened by the passage of one tooth of the escape wheel that intermittently moves twice per balance wheel oscillation.

Another reflection-mode experiment captured the heating-induced rupture of a popcorn kernel. As shown in FIG. 5D, the kernel was held upright by a metal holder and heated by a forced stream of hot air from a heat gun. The SPI-ASAP system imaged this event at 298 fps (with 50% sampling) and with a FOV of 14 mm×14 mm (41×43 pixels). The reconstructed movie is shown with selected frames shown in FIG. 5E. As visualized in FIG. 5F, the rupture of the kernel's shell initiated on its upper right side with the subsequent expansion of the kernel's interior causes the kernel to be pulled from the holder by the air stream.

### SPI-ASAP in Strong Ambient Light

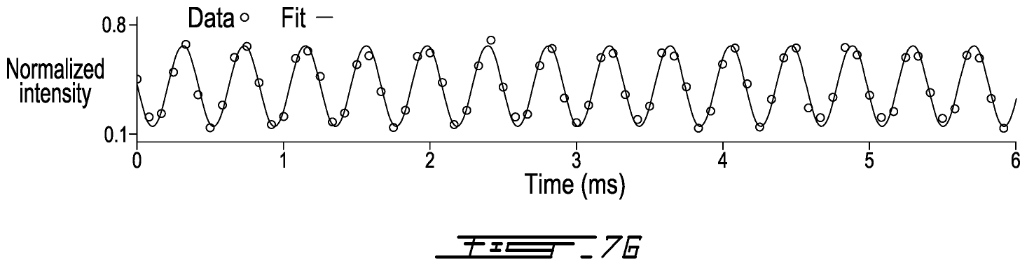

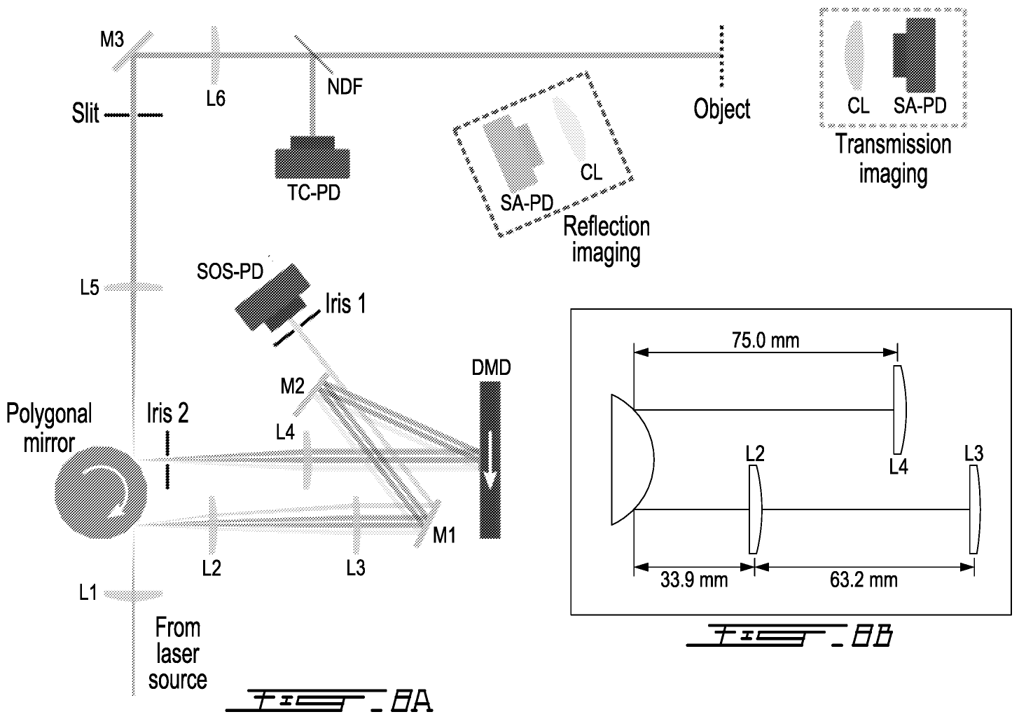

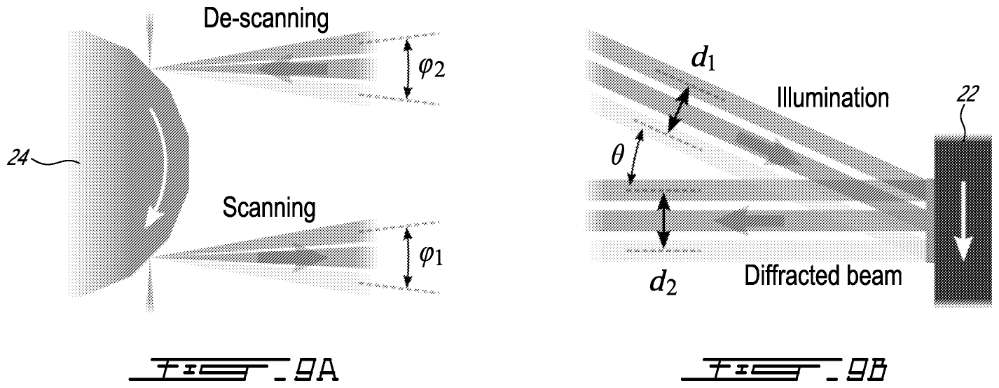

Since an imaging relationship need not exist between object and detector in SPI, SPI systems can tolerate optical disruption of the imaging beam that may occur between the pattern-illuminated object and detection with the non-imaging sensor, which well-positions SPI for scenarios requiring extreme optical filtering, such as for scenes involving intense and varying ambient light. To demonstrate this capability in high-speed SPI-ASAP, the current-induced failure of incandescent light bulb filaments in two experimental conditions is studied (FIG. 6C). To remove the strong and time-varying incandescence, spatial and chromatic filtering stages on the detection side are built (see details in Supplementary Note 5 hereinbelow). SPI-ASAP operated at 298 fps (50% sampling) and with a FOV of 11 mm×11 mm (41×43 pixels).

The first experiment used a sealed un-modified bulb (FIG. 6A). Selected frames from a reconstructed video are shown in FIG. 6B. The burn-out of the filament occurred after 3-5 seconds of increasing incandescence. The result reveals that the failure occurred at the left connection between the filament and the supporting wire lead, followed by the deposition of the vaporized metal from the supporting wires on the interior of the glass bulb surface. This process led to a reduced transmission through the bulb, which is observed in FIG. 6B as an overall darkening following the initiation of the failure (FIG. 6C).

As a comparison, in the second experiment the cover glass of the bulb was removed (FIG. 6D). The evolution of this dynamic event of a video, with selected frames is presented in (FIG. 6E). In contrast to the first experiment, the filament exposed to air had a quicker failure, which initiated after 1-2 seconds of increasing incandescence. Moreover, failure occurred in the filament material itself from combustion due to the presence of oxygen in air. The result also reveals the emission of smoke and vaporized material as well as the ejection of a section of filament material that fell onto and fused with the portion of glass bridging between the filament support wires. Finally, FIG. 6F. shows the time evolution of the background intensity of an identical region of background pixels as that shown in FIG. 6C.

### Ultrahigh-Speed SPI-ASAP at 12 kfps

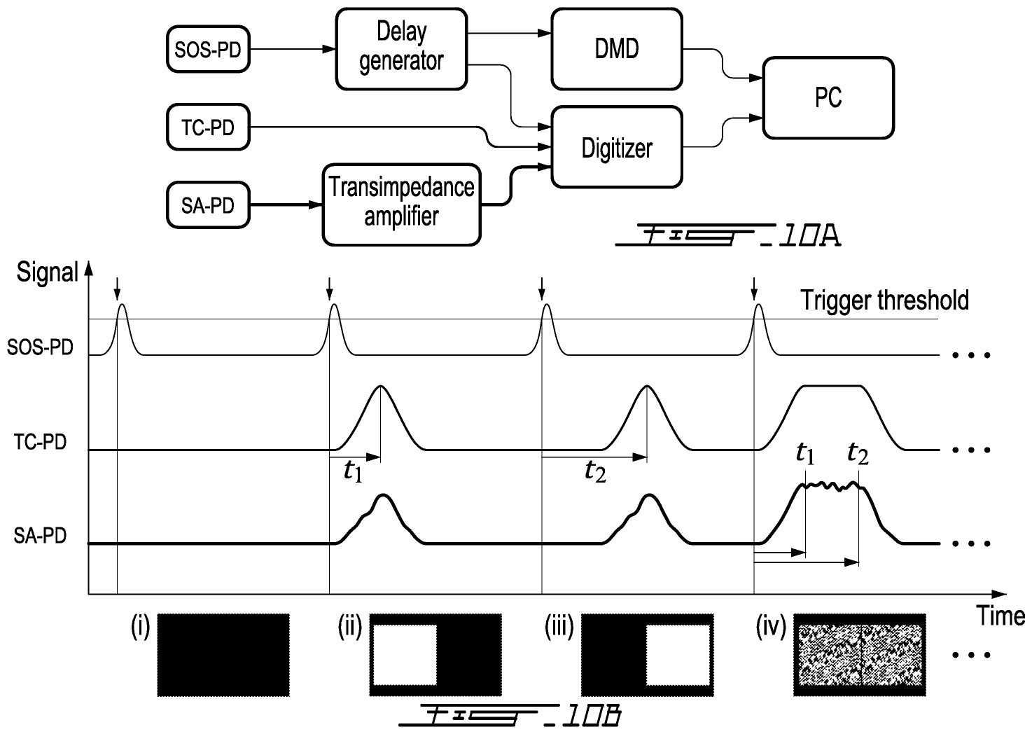

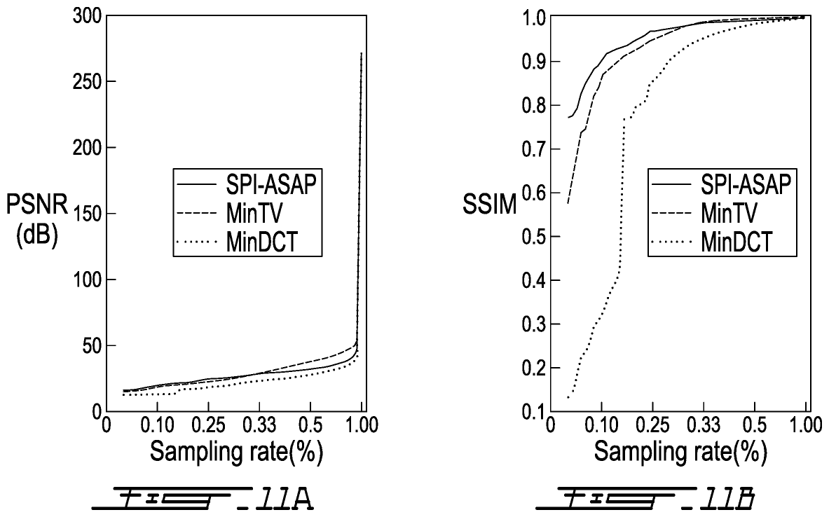

For the above-discussed experiments, the operation of SPI-ASAP requires the scan-synchronized deployment of multiple aggregate patterns by the DMD, whose maximum refresh rate limits the system's performance. To further increase the imaging speed, data acquisition was carried out at the maximum scan rate of the polygonal mirror, i.e., 12 kHz, with a single static mask that combined a sufficient number of aggregate patterns to allow for reconstruction at 55% sampling (see details about the pattern generation and signal timing are included in Supplementary Note 6 hereinbelow). Using this experimental configuration, a 30-slot optical chopper rotating at 4800 RPM is imaged (FIG. 7A). The SPI-ASAP system imaged five different locations, each with a FOV of 10 mm×10 mm and a frame size of 11×13 pixels.

FIGS. 7B-7F show consecutive frames from dynamic videos captured at 12 kfps, thus demonstrating the maximum possible frame rate of SPI-ASAP based on its current hardware. A time history of normalized intensity from a selected pixel is shown in FIG. 7G. By using a sinusoidal fitting, the wheel chop rate was determined to be 2408.9 Hz corresponding to a linear speed at the edge of the wheel of 25.7 m/s, in excellent agreement with the experimental conditions.

### Demonstration of Real-Time SPI-ASAP

The reconstruction algorithm adopted by SPI-ASAP is well-suited for real-time operation, in which recovery and display of images must follow acquisition immediately with minimal delay. A filmed demonstration of SPI-ASAP operating in real-time for a variety of scenes, frame sizes, and frame rates showed the system operating at a frame size of 59×61 pixels with a real-time display at 51 fps and 99 fps, corresponding to 100% and 50% sampling, respectively, a 71×73-pixel frame size at 83 fps (50% sampling), and a 101×103-pixel frame size at 96 fps (30% sampling). GPU-computed matrix multiplications for image reconstruction typically required 0.4 ms. Data processing times, encompassing the registration of photodiode signals, image reconstruction, and display, were typically 1.0 ms.

### Discussion

SPI-ASAP uses swept aggregate patterns to enhance the capabilities of SPI for ultrahigh-speed and real-time imaging. In contrast to prior art SPI methods, the present SPI-ASAP synergizes DMD modulation and polygonal mirror scanning to leverage the flexible and reconfigurable pattern projection of DMDs while extending the rate of pattern deployment by over two orders of magnitude. SPI-ASAP was demonstrated for high-speed and real-time imaging by recording various dynamic scenes in both reflection and transmission across various frame sizes. In both the reflection and transmission modes, SPI-ASAP shows its flexibility for frame size and frame rate, resilience to strong ambient light, and its capability of ultrahigh-speed imaging at up to 12 kfps.

SPI-ASAP's performance may be further enhanced by optimized selections of DMD and laser scanning hardware. The pattern deployment rate of the current SPI-ASAP system is limited by the maximum display rate of the DMD used, i.e., 6.37 kHz, which was approximately 53% of the 12 kHz maximum scan rate of the polygonal mirror. As discussed in Supplementary Note 3 hereinbelow, the scan duty cycle of the current SPI-ASAP system is compatible with an approximately 10× increase in mirror facet count, which corresponds to a maximum scan rate of 120 kHz using 45,000 RPM motorization. Use of a fastest DMD, with a 32 kHz refresh rate, may increase the performance of SPI-ASAP by five times, and may increase ultrahigh-speed SPI-ASAP performance by a factor of 10. Finally, the interpolation method for SPI-ASAP as described herein is designed to maximally leverage the parallel computing ability of GPUs. Other interpolation methods may be contemplated for improving reconstruction quality while maintaining fast reconstruction.

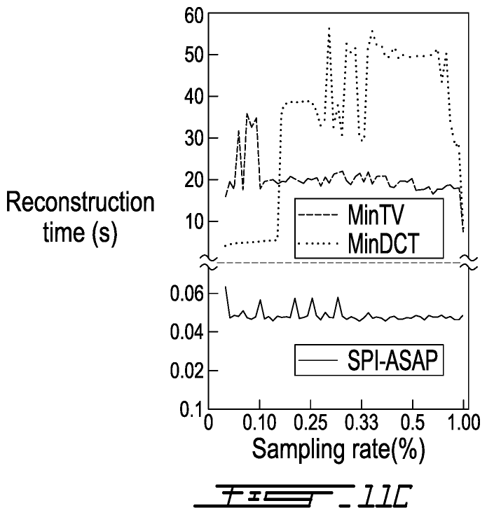

As primarily a source of structured illumination, DMDs also impose restrictions for the optical sources compatible with SPI-ASAP, which must both be compatible with the size, of about 10 μm, of individual DMD micromirrors under the diffraction limit, as well as the transmission properties of the DMDs' cover window. Frame size and FOV are also dependent on the DMDs' size and pixel count, as well as the noise and bandwidth properties of the photodiode. Owing to the correlative behavior of the swept masks, information of image structure is represented in small variations in photodetector signals, which, in general, fluctuate more rapidly and with decreased amplitude as the frame size of deployed patterns is increased. Consequently, the photodiode's signal-to-noise ratio (SNR) may ultimately limit frame size and scanning rate under the coding method of SPI-ASAP. Meanwhile, the focal lengths and clear apertures of the optics that image the DMD-displayed patterns to the object, i.e., L4—L6 in FIGS. 2 and FIG. 8 constrain the optical bandwidth of pattern projection, which thus limits SPI-ASAP's frame sizes by constraining the minimum pixel size of encoding patterns to be compatible with the system's optical point spread function. Additionally, timing inaccuracies caused by the polygonal mirror's defects and the continuous motion of the encoding patterns attribute to an anisotropic spatial resolution. Investigation of this property of SPI-ASAP and an analysis of contributing factors are provided in Supplementary Note 7 hereinbelow and FIG. 14.

As a coded-aperture imaging modality, SPI-ASAP holds promises in terms of broad application scope. Besides the active-illumination-based applications demonstrated in the present disclosure, the principle of SPI-ASAP is readily applicable to high-speed imaging with passive detection, which may open new routes to applications that rely on self-luminescent events, such as optical property characterization of nanomaterials and the monitoring of neural activities, for example. SPI-ASAP for imaging in strong ambient light conditions may also be adopted for the study of combustion phenomena for example. The non-imaging relationship between object and detector in SPI-ASAP indicates its potential applications for non-line-of-sight imaging. Combining SPI-ASAP with 3D profilometry will lead to the immediate application of scene relighting on high-speed 3D objects. Extending the operational spectral range of SPI-ASAP may enable fast hazardous gas detection. As another example, SPI-ASAP may find applications in inducing patterned regions of high conductivity in a semiconductor material for high-speed 2D THz imaging.

### Methods—Geometry of Beam Scanning

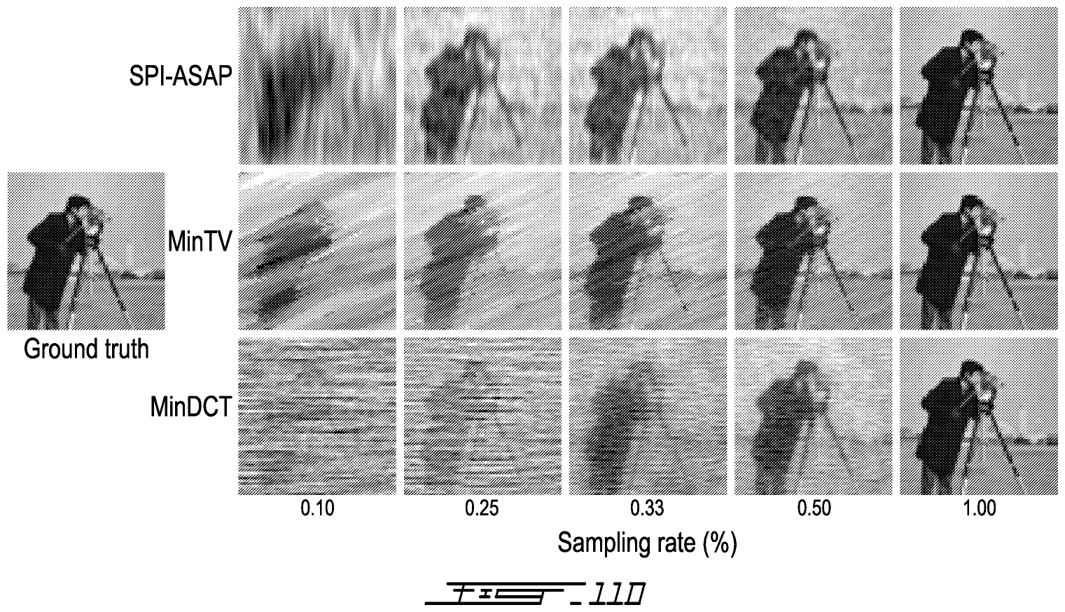

SPI-ASAP uses a rotating polygonal mirror for translating scanned illumination of the DMD surface into the swept deployment of encoding patterns. Closeups of the polygonal mirror and DMD reflections producing the scan behavior are illustrated in FIG. 9. The basis of this behavior is the angular correlation of the scanned and de-scanned beams during mirror rotation. This requirement can be expressed by φ₁=φ₂ for scan angles φ₁=φ₂ (see FIG. 9A) for light that respectively illuminates and is reflected by the DMD surface. At the position of the DMD shown in FIG. 9B, this requirement transfers to the correlation of lateral beam shifts as the DMD surface is scanned by illumination with an incident angle of θ=˜24°. If scan optics with a focal length f₁ are used to collimate the illuminating beam, the generated lateral shift is expressed by d₁=f₁φ₁. Subsequent reflections of the beam by planar mirrors M do not alter such lateral shifts. As illustrated by the geometry of FIG. 9B, the diffraction of the DMD produces a lateral shift of d₂=d₁ sec θ. De-scanning optics of focal length f₂, re-focusing the reflected beam, then produce an angular variation of φ₂=d₂/f₂. Combining this information produces the requirement f₁=f₂ cos θ, which dictated the selection of lenses L2-L4 in the SPI-ASAP system. For de-scanning, a single lens (L4) was chosen. For scanning, two lenses (L2 and L3) with specific positioning were used to produce the required effective focal length. Details of lens selection and positioning are included in Supplementary Note 1 hereinbelow.

### Cyclic S-Matrices

SPI-ASAP encodes measurements by using cyclic S-matrices. In general, S-matrices are defined as the class of {0,1}-valued matrices that possess a maximal possible value of the determinant. It can be shown that for a non-trivial S-matrix S of order,

$$\\ \begin{matrix}{S}^{{}^{} - 1} = \frac{2}{n + 1} ( 2 {S}^{T} - J ) , & ( 2 )\end{matrix}$$

where J denotes the all-one matrix with size n×n, S^{T} denotes the matrix transpose of S, and n must be of the form 4k−1 for some positive integer k. In the case of cyclic S-matrices, an additional cyclic structure is imposed by which the initial row determines all subsequent rows via left-wise circular shifts. Let S_{i,j} denotes the element of S with row index i and column index J. The initial row S_{0,j}(j=0, . . . , n−1) then determines all elements of S as follows:

S_{i,j}=S_{0, i+j}, (3)

where i=0, . . . , n−1, and the indices are interpreted modulo n. The consequences of the circular structure are that S is symmetric, i.e. S=S^{T}, and that S⁻¹ is also circular. Several methods are known for the construction of cyclic S-matrices. For imaging, it is desirable that n can be factorized into parts of approximately equal size. Given any pair of twin primes p and q=p+2, it is possible to construct a cyclic S-matrix of order n=pq.

The computation of S_{0,j} depends on the following property. An integer x is called a quadratic residue (mod y) if x≠0 (mod y) and there exists another integer z such that x≡z² (mod y). In this case, the following functions can be defined as follows:

$$\\ \begin{matrix}f ( j ) = \{ \begin{matrix}+ 1 & if j is a quadratic residue ( mod p ) \\ 0 & if j ≡ 0 ( mod p ) \\ - 1 & otherwise\end{matrix} and & ( 4 )\end{matrix}$$

$$\\ \begin{matrix}g ( j ) = \{ \begin{matrix}+ 1 & if j is a quadratic residue ( mod q ) \\ 0 & if j ≡ 0 ( mod q ) \\ - 1 & otherwise\end{matrix} , & ( 5 )\end{matrix}$$

from which S_{0,j} of a cyclic S-matrix of order n=pq can be computed by

$$\\ \begin{matrix}{S}_{0 , j} = \{ \begin{matrix}0 & if [ f ( j ) - g ( j ) ] g ( j ) = 0 \\ + 1 & otherwise\end{matrix} . & ( 6 )\end{matrix}$$

Aggregate pattern sequencing and data segmentation for video reconstruction

For video reconstruction, the smallest units of data considered for frame segmentation corresponded to the scans of individual aggregate patterns. Each scan produces a sequence of q bucket signals comprising a completed row of Y (FIG. 3C). Each frame of reconstructed video is then produced from a fixed number of scans (denoted by L) allocated into consecutive non-overlapping segments from a dataset recorded continuously during experiments. Additional scans of three registration patterns appended to the start of the pre-stored sequence (see Supplementary Note 2) are excluded during frame segmentation. As a result, the average framerate fᵣ of recovered videos is selectable at the time of reconstruction as follows:

$$\\ \begin{matrix}{f}_{r} = \{ \begin{matrix}\frac{{f}_{s}}{L + 3} & if L = p \\ \frac{{f}_{s}}{L + 3 \frac{L - 1}{p}} & if L < p\end{matrix} , & ( 7 )\end{matrix}$$

where fₛ is the scan rate of the polygonal mirror which for the experiments (except for ultrahigh-speed imaging), was 6.37 kHz, limited by the maximum refresh rate of the DMD. According to the above relation (7) and the system settings, one can determine information such as the maximum imaging speed under the acceptable resolution, or maximum imaging resolution meeting the minimum requirements for real-time imaging at 24 fps. This relation establishes the average framerate fᵣ of recovered video for high-speed and/or real-time SPI-ASAP, as a function of vertical frame size p, number of recorded scans L, and the polygonal mirror scan rate fₛ that was fixed at 6.37 kHz. The sampling ratio of such an arrangement is therefore L/p, and the horizontal frame size q via the twin-prime construction of the encoding patterns (as described hereinabove) satisfies q=p+2. Finally, as described hereinabove, the exclusion of the three registration patterns from frame segmentation resulted in a slightly non-uniform frame period. This effect is however captured by the above formula by reporting an average. The demonstration of ultrahigh-speed SPI-ASAP, on the other hand, entailed a simplified relationship between scan rate and frame rate, for which fᵣ=fₛ, with fₛ held at the maximum scan rate of the polygonal mirror of 12 kHz. In addition, additional constraints on the imaging frame size p×q are imposed by the finite pixel count of the DMD. In particular, the DMD must be capable of displaying the individual aggregate patterns of p×(2q−1) in size as discussed hereinabove. For the ultrahigh-speed configuration, fitting multiple aggregate patterns within one DMD pattern results in a more constrained range of acceptable frame sizes, with the dimensions of the total pattern scaling in the way depicted in FIG. 13.

In operation, a complete sequence of aggregate patterns is pre-stored by the DMD and displayed iteratively. To support sub-sampling, aggregate patterns are displayed in a permuted order that allows groups of L<p consecutive scans to fill the rows of Y with approximately uniform spacing. By numbering the aggregate patterns with k=0, . . . , p−1 corresponding to the rows of Y, the display of the aggregate patterns took place in the order d₀, d₁, . . . , dₚ₋₁ where the sequence of values dₖ was defined as follows:

d₉=0, and

dₖ₊₁=dₖ=c (mod p). (8)

c is a constant chosen from the inspection of the sampling uniformity for various values of L. As a consequence of using cyclic S-matrices derived from the twin-prime construction, p is prime, and thus relation (8) hereinabove defines a permutation for any value of c≠0 (mod p). The preferred values of c used for the presented experiments are summarized in the table in FIG. 17.

Interpolation-based image reconstruction using matrix operations

To take full advantage of GPU hardware for real-time visualization, SPI-ASAP's image reconstruction uses matrix multiplication for direct parallelization, typically by interpolation and image recovery. For a segment of L consecutive scans deployed in a permuted order, recorded data are represented by a L×q matrix M whose elements M_{i, j} respectively denote the j^{th} bucket signal (j=0, . . . , q−1) acquired from the deployment of the i^{th} aggregate pattern (i=0, . . . , L−1).

The goal of interpolation is to transform M into an estimate of the smooth bucket signal matrix Y. This transformation can be computed by matrix product as follows:

(9) (9)

where the matrices V (size q×q) and W (size p×L) are selected to carry out optional row-wise low-pass filtering, and column-wise interpolation, respectively. Both the matrices V and W can be pre-computed and stored with low overhead owing to their sizes scaling linearly to the frame size of reconstructed images. Details of the pre-computations involved for the elements of the matrices W and V are provided in Supplementary Note 8 hereinbelow.

Then, by reshaping Y back into an n-element vector y, the reconstruction of a 2D image x follows by direct inversion according to relation (1) hereinabove. Because the structure of S⁻¹ is cyclic, computation of x becomes equivalent to a convolution of y with the initial row of S⁻¹, as follows:

x=y*s₀⁻¹, (10)

where s₀⁻¹ is the initial row of S⁻¹, and the operator * denotes discrete circular convolution.

During the real-time operation, parallelization of reconstruction computations was facilitated with the use of a GPU (GeForce GTX 1060, NVIDIA). Frame rates were limited by the rate of data acquisition from scanning, with reconstruction and display taking place quickly enough to consume all incoming data.

As illustrated in FIG. 2, beam scanning of a DMD-displayed aggregate pattern (see FIG. 2B) is achieved by rotation of a polygonal mirror, arrows indicating directions of polygonal mirror rotation and illumination scanning.

### Supplementary Material

### Supplementary Note 1: System Used in Experiments

An illustration of the experimental setup of single-pixel imaging accelerated via swept aggregate patterns (SPI-ASAP) is shown in FIG. 8A. Light from a continuous-wave laser source (200 mW power, 671 nm wavelength, MRL-III-671, CNI Laser) illuminates a high-speed projection module, whose core components are a polygonal mirror (Gecko-45-HSS, Precision Laser Scanning) and a digital micromirror device (DMD, AJD-4500, Ajile Light Industries). This high-speed polygonal mirror consists of 16 planar facets and has scanning rates at 2.7-12 kHz (corresponding to 10,000-45,000 RPM). The double-reflection configuration increases optical efficiency by allowing illumination to be concentrated on only the parts of the DMD surface that are transmitted by the system. In particular, the laser beam is focused by the lens L1 (30 mm focal length) to a moving facet of the polygonal mirror placed at the lens' focal plane. The reflected beam is collimated by lenses L2 (75 mm focal length) and L3 (125 mm focal length) that are separated by 63.2 mm (FIG. 8B) so as to produce an effective focal length appropriate for de-scanning by lens L4 (75 mm focal length). Thus, the mirror rotation is transferred to the lateral translation of the beam with its chief ray parallel to the optical axis (detailed in Methods hereinabove). Then, the beam is reflected by two flat mirrors M1 and M2. A small portion of the beam passes beyond the edge of M2 and enters Iris 1 so that the start-of-scan photodiode (SOS-PD), (DET100A2, Thorlabs) triggers the display of a new aggregate pattern that is pre-stored by the DMD. The rest of the beam scans across the DMD surface with an incident angle of θ=˜24°.

The diffracted beam from the DMD, which is spatially modulated by the displayed aggregate pattern, is imaged to a slit via a 4-f imaging system consisting of lenses L4 and L5 (75 mm focal lengths) as well as a moving facet of the polygonal mirror placed at L4's focal plane. Iris 2, positioned close to the polygonal mirror, selects the strongest diffraction order. The width of the slit determines the encoding patterns by optically selecting the sub-regions in the aggregate pattern. The intermediate image at the slit is further relayed by lens L6 (100 mm focal length) to the object with a varied magnification of 2-5×. Along the beam path, an adjustable neutral density filter (NDF) controls the illumination intensity while sending the reflected beam to the “time coding” photodiode (TC-PD, DET36A2, Thorlabs). Depending on the operational mode, the transmitted or reflected light of the object is focused by a condenser lens (CL) to the signal acquisition photodiode (SA-PD) (DET36A2, Thorlabs) whose output waveforms are amplified by a transimpedance amplifier (OPA1S2384EVM, Texas Instruments).

### Supplementary Note 2: System Timing and Data Registration

Shared synchronization between the DMD and polygonal mirror is achieved so that the DMD-displayed patterns are updated in tandem with the passage of individual facets of the polygonal mirror; synchronization speed is larger than 6 KHz. Synchronization may be omitted in modes of operation involving the display of non-reconfigurable encoding patterns.

Signal path and timing diagrams are illustrated in FIG. 10. As shown in FIG. 10, each mirror scan produces a pulsed signal from the SOS-PD. From these signals, a delay generator (DG645, Stanford Research Systems) generates a per-scan timing datum via triggering on the rising edge of a pre-set voltage threshold. Outputs from the delay generator then trigger the refresh of DMD patterns as well as the acquisition of data using a digitizer card (ATS9350, AlazarTech) that interfaces with a computer. Data from both the TC-PD and the SA-PD are synchronously stored as waveforms consisting of 1024 points of 12-bit measurements sampled at a rate of 20 MHz.

The SA-PD waveforms are registered with the corresponding sub-areas in each aggregate pattern by using three special-purpose registration patterns appended to the beginning of the pre-stored DMD pattern sequence. Illustrated examples of SOS-PD, TC-PD, and the SA-PD waveforms corresponding to these registration patterns are shown in FIG. 10B. The first pattern (marked as (i) in FIG. 10B) is all dark and serves as a datum for matching the waveforms measured by the TC-PD and the SA-PD to the aggregate pattern sequence. The second and third patterns (marked as (ii) and (iii) in FIG. 10B) consist of “On” DMD pixels in the initial and final encoding pattern sub-regions of the aggregate pattern, respectively. In SPI-ASAP, these patterns produce triangular TC-PD waveforms, whose peak locations supply timing offsets t₁ and t₂ that identify the positions of the initial and final deployed masking patterns (see an example labeled by (iv) in in FIG. 10B) in the SA-PD waveform. Sampling of bucket signal values then follows by linear interpolation of sample locations within the [t₁, t₂] interval.

### Supplementary Note 3: Performance for SPI Using Polygonal Mirror Scanning

The selection of a polygonal mirror simultaneously addresses several limitations of method and system using galvanometer mirrors and resonant scanning mirrors. First, the ability to simultaneously deflect off of two separate mirror facets in the same device allows for scanning hardware to be consolidated, thus avoiding the synchronization of multiple mechanical devices. Second, because the angular speed of the facets on the polygon mirror remains constant in operation, motorization is simplified thus allowing for many-faceted polygons to achieve scan rates above 10 kHz. Scan rates may also be continuously varied with the rotational speed of the motor, thus increasing flexibility over resonant scanning mirrors whose period of oscillation is fixed. In addition, the time dependence of the scan angle for polygonal mirrors is linear, thus avoiding the need for precise calibration of control signals. Finally, by eliminating the deceleration period required by GMs and resonant scanning mirrors, polygonal mirrors allow for increased scan duty cycles, which may be optimized via the correct selection of facet count.

For the SPI-ASAP system presented herein, the use of off-the-shelf hardware dictated the use of a 16-sided mirror polygon. For aggregate patterns making use of the full DMD surface, this restriction resulted in a pattern deployment duty cycle of approximately 8%. Consequently, the rate of pattern modulation for SPI-ASAP was non-constant, with the current system compatible with roughly a 10× increase in polygon facets. To demonstrate the performance of SPI-ASAP with optimized facet count, modulation rates shown in the table of FIG. 16 are computed relative to the pattern deployment interval, thus reflecting the peak modulation rate during operation.

### Supplementary Note 4: Comparison of Conventional CS Methods with SPI-ASA

To verify the performance of SPI-ASAP's reconstruction method, image reconstruction between SPI-ASAP and two widely used compressive reconstruction algorithms implemented with the L1-Magic software library were compared. The first algorithm, referred to as MinTV, is regularized based on the total variation (TV). The second algorithm, referred to as MinDCT, is regularized from sparse representations using the basis of the discrete cosine transform (DCT). The MinTV and MinDCT reconstruction algorithms are defined based on the following optimization programs found in the L1-Magic software package:

$$\\ \begin{matrix}{arg min}_{x} TV ( x ) subject to {‖ Sx - y ‖}_{2} \leq ϵ , & ( MinTV )\end{matrix}$$

$$\\ \begin{matrix}{arg min}_{x} {‖ Ψ x ‖}_{1} subject to {‖ Sx - y ‖}_{2} \leq ϵ , & ( MinDCT )\end{matrix}$$

where x is the image to be recovered, y is the vector of bucket signals, S is the measurement matrix, ∈ is a user-specified parameter, and μ⋅μ, denotes the l₁-norm. For an image with dimensions p×q, the total variation TV(x) is defined as follows:

TV(x)=Σⱼ₌₁^{p-1}Σⱼ₌₁^{q-1}{square root over ([x(x(x+1,ij)−x(i,j]²+[x(i,j+1)−x(i,j)]²)}, (S1)

where x(i,j) indicates the value of the pixel of x with coordinates (i,j). Finally, Ψ denotes the real orthogonal matrix that induces the DCT.

For quantitative comparison of the agreement between a reconstruction x and ground truth image \hat{x}, both the peak signal-to-noise ratio (PSNR) and structural similarity index (SSIM) are used as metrics to compute reconstruction error. The PSNR and SSIM are defined as follows:

$$\\ \begin{matrix}PSNR ( x , \hat{x} ) = 10 {log}_{10} ( \frac{{( max ( \hat{x} ) )}^{2}}{( 1 / pq ) {‖ x - \hat{x} ‖}_{2}^{2}} ) , and & ( S2 )\end{matrix}$$

$$\\ \begin{matrix}SSIM ( x , \hat{x} ) = \frac{( 2 {μ}_{1} {μ}_{2} + {C}_{1} ) ( 2 {σ}_{12} + {C}_{2} )}{( {μ}_{1}^{2} + {μ}_{2}^{2} + {C}_{1} ) ( {σ}_{1}^{{}^{} 2} + {σ}_{2}^{{}^{} 2} + {C}_{2} )} . & ( S3 )\end{matrix}$$

where max(\hat{x}) denotes the maximum intensity value of the ground truth image. μ₁ and μ₂ denote the mean intensity values of x and \hat{x}, respectively. ol and o denote the variances of the intensity values of x and \hat{x}, respectively. σ₁₂ denotes the covariance of x and \hat{x}. The constants C₁ and C₂ are used to prevent indeterminate values of SSIM and were set to the conventional values (0.01 max(\hat{x}))² and (0.03 max(\hat{x}))², respectively.

For the iterative reconstruction methods based on convex optimization, the selection of the user-defined parameter E plays a crucial role in the performance of MinTV and MinDCT. In the present numerical experiment, ∈ was selected based on a golden section search that first optimized the PSNR against the ground truth image. Thus, the results of the MinTV and MinDCT methods FIG. 11 could be interpreted as optimized with respect to the selection of ∈.

The time overhead required for reconstructions provided by each method using a computer with an Intel® Core™ i5-8250U CPU (1.60 GHz) and 8 GB RAM was measured. Input to each reconstruction method included identical measurement matrices and simulated bucket signals. All measurement matrices were composed in accordance with SPI-ASAP's aggregate pattern coding method. No noise was injected in this experiment.

The results of this comparison, shown in FIG. 11, indicate that in terms of PSNR and SSIM, the performance of SPI-ASAP largely meets or exceeds that of the iterative methods, in particular outperforming them across both metrics for the case of sampling rates below 50%. This observation is qualitatively matched by the subset of image reconstruction results shown in FIG. 11D. For the case of 100% sampling, a highly accurate convergence is noted across all methods as indicated by the pronounced maxima exhibited by the PSNR metric. Measurements of reconstruction time required for each algorithm (FIG. 11C) provide the most striking comparison between SPI-ASAP and the conventional methods, with SPI-ASAP reconstructions exhibiting consistent running times 2-3 orders of magnitude below those of both conventional methods.

### Supplementary Note 5: Details of High-Speed Imaging of Incandescent Filaments

The system for acquiring optically filtered bucket signals is illustrated in FIG. 12. The incandescent filament was placed at SPI-ASAP's image plane, which was in the front focal plane of lens L1 (75 mm focal length). Iris 1, positioned in the back focal plane of L1, blocked the majority of incandescent rays that were approximately collimated. Lens L2 (75 mm focal length), in a 4-f configuration with L1, relayed the image of the filament to the surface of a diffraction grating (600 line/mm, GR13-0605, Thorlabs) from which the first diffraction order was selected. The grating was positioned on the focal plane of lens L3 (100 mm focal length), which produced a chromatically dispersed image of Iris 1 at Iris 2. Finally, 671 nm light chromatically selected by Iris 2 was focused by the condenser lens to SA-PD.

The light bulbs used in the experiments were designed for low-power applications (rated 12 V, 18 W) and were commercially sourced. In each experiment, filament burn-out was initiated by the application of 24 V with a DC power supply. Imaging experiments were repeated several times for each case with consistent results.

### Supplementary Note 6: Details of Ultra-High-Speed Imaging at 12 kfps

The timing and data registration system used for ultra-high-speed imaging with SPI-ASAP is illustrated in FIG. 13. For this imaging system, bucket signals are generated from a single displayed DMD pattern that remains static during the scanning of the polygonal mirror at its maximum speed of 12 kHz. The static DMD pattern is comprised of six jointly arranged aggregate patterns, each designed with a resolution of 11×13 pixels. Thus, this DMD pattern carried a total of 78 masking patterns corresponding to a sampling rate of 55%.

Data registration for the joint aggregate pattern proceeded similarly to the procedure described in Supplementary Note 2 hereinabove with two exceptions. First, multiple intervals were used to derive bucket signals. Second, registration patterns were not displayed synchronously with the collection of data. The registration patterns, shown by insets (i) and (ii) in FIG. 13, consisted of joint copies of the registration patterns appropriate for each segment of the joint aggregate pattern. Waveforms for the TC-PD and the SA-PD were sampled at 50 MHz with TC-PD waveforms being collected separately for each registration pattern. The locations of the six triangular peaks within each TC-PD waveform then supplied timing offsets t₁⁽ⁱ⁾ and t₂⁽ⁱ⁾ (i=1, . . . , 6) that identified the positions of the initial and final encoding patterns deployed by each segment of the multi-aggregate pattern. Linear interpolation of sample locations within the six intervals [t₁⁽ⁱ⁾, t₂⁽ⁱ⁾] (i =1, . . . , 6) then determined bucket signal values from BD-PD waveforms collected during the experiment.

Video reconstruction was carried out in a one-to-one fashion with the SA-PD waveforms, with the 78 bucket signals derived from each waveform leading to the reconstruction of individual frames in sequence. The time interval to acquire each frame was approximately 6.7 μs.

### Supplementary Note 7: Investigation of Spatial Resolution of SPI-ASAP

To investigate the spatial resolution of SPI-ASAP, a resolution target (1951 USAF) was imaged at four rotation angles between 0° and 90°. The SPI-ASAP system had a frame size of 59×61 pixels across a FOV of size 5.5 mm (i.e., each pixel is 90 μm in size), which was the most typical setting used in the described experiments. At each rotation position, the image was obtained as temporal averages of 89 consecutively collected frames. For frame reconstruction, spatial filtering was disabled via the choice of T=0 in relation (S5), which set the spatial filtering matrix V equal to the identity (see Supplementary Note 8). Line profiles of normalized intensity were then extracted that were tracked to individual elements of the resolution target over each rotation position.

Imaging results are illustrated in FIG. 14. Evidence of a non-isotropic spatial resolution can be observed in the variation of line profile modulation depth with the rotation angle of the resolution target. Using the criterion of 5% contrast, a horizontal resolution of 198.4 μm identified as the resolution target line width (Group 1, Element 3) corresponding to profile 2 shown in FIG. 14A was determined. Similarly, a vertical resolution of 88.4 μm identified as the resolution target line width (Group 2, Element 4) corresponding to profile 2 shown in FIG. 14B was determined.

Two factors may be identified as contributing to the resolution anisotropy. First, to prioritize speed, SPI-ASAP's data registration procedure (see Supplementary Note 2 hereinabove) does not compensate for encoding pattern motion that occurs during intervals sampled for each bucket signal. For a scan rate of 6.37 kHz and a modulation duty cycle of 8%, the time interval containing bucket measurements is of duration 0.08/6.37 kHz=12.6 μs. Consequently, for 59x61-pixel imaging, a shift of one encoding pixel occurs after a period of 12.6 μs/61 =0.21 μs. Thus, with 20 MHz sampling of the SA-PD waveforms, a pattern shift of ±0.12 encoding pixels occurs within the sampling interval. Second, the TC-PD waveforms exhibited a 16-period timing variation produced from minute errors in the facet geometry of the polygonal mirror. For high-speed imaging, this resulted in a timing variation of 0.19 μs, equivalent to ±0.45 encoding pixels. Although the extraction of appropriate timing offsets for data registration was stabilized by temporal averaging, timing variations affecting the registration of bucket signals is still capable of affecting reconstruction results via row-wise misalignment of data within the bucket signal matrix Y.

### Supplementary Note 8: Details of Matrix Pre-Computations for Interpolation-Based Image Reconstruction

### Derivation of V

Let F denote the q×q matrix of the discrete Fourier transform (DFT) of order q, which is defined by F_{i,j}=ω⁻ⁱ), where i and j range over (0, . . . , q−1), and ω is a primitive q^{th} root of unity. The inverse of this matrix can be computed by F⁻¹=(1/q)F*, where F* denotes the complex conjugate transpose of F. The row-wise spatial filtering of a matrix M can be written as follows:

$$\\ \begin{matrix}MV = {( \frac{1}{q} {F}^{{}^{} *} {DFM}^{{}^{} T} )}^{T} = M ( \frac{1}{q} {FDF}^{{}^{} *} ) , & ( S4 )\end{matrix}$$

where the matrix D is diagonal and selects the spatial frequencies retained from the DFT. For a symmetric low-pass filter whose cut-off frequency is denoted by T (2T≤q), the diagonal elements of D can be defined as follows:

$$\\ \begin{matrix}{D}_{i , i} = \{ \begin{matrix}0 & if T < i < q - T \\ 1 & otherwise\end{matrix} , & ( S5 )\end{matrix}$$

from which the elements of V can be computed as follows:

$$\\ \begin{matrix}{V}_{i , j} = \frac{1}{q} {FDF}^{{}^{} *} = \frac{1}{q} [ 1 + 2 {\sum }_{k = 1}^{T} cos ( 2 π ( i - j ) k / q ) ] . & ( S6 )\end{matrix}$$

Across the experiments, only mild low-pass filtering was used, with values of T selected to retain 70%-80% of the spectrum of the DCT.

### Derivation of W

Column-wise interpolation was developed as a special case of piecewise cubic spline interpolation with cyclic boundary conditions. As illustrated in Supplementary FIG. 8, from the four data points shown, a cubic interpolating polynomial f(x) can be specified for values x₁≤x<x₂, as follows according to the boundary conditions:

f(x₁)=Y₁,

f(x₂)=Y₂,

f′(x₁)=g₁, and

f′(x₂)=g₂, (S7)

where the values of g₁ and g₂ are chosen as the average slopes between the two line-segments that meet at positions x₁ and x₂, respectively, as follows:

$$\\ \begin{matrix}{g}_{1} = \frac{1}{2} ( \frac{{y}_{1} - {y}_{0}}{{x}_{1} - {x}_{0}} + \frac{{y}_{2} - {y}_{1}}{{x}_{2} - {x}_{1}} ) , and {g}_{2} = \frac{1}{2} ( \frac{{y}_{2} - {y}_{1}}{{x}_{2} - {x}_{1}} + \frac{{y}_{3} - {y}_{2}}{{x}_{3} - {x}_{2}} ) . & ( S8 )\end{matrix}$$

For fixed values of x₀, . . . , x₃ and x, values of the resulting interpolation function y=f(x) are linear with respect to the y-coordinate data y₀, . . . , y₃ and can be computed as follows:

$$\\ \begin{matrix}y = H ( {x}_{0} , {x}_{1} , {x}_{2} , {x}_{3} , x ) [ \begin{matrix}{y}_{0} \\ {y}_{1} \\ {y}_{2} \\ {y}_{3}\end{matrix} ] , & ( S9 )\end{matrix}$$

where H(x₀,x₁,x₂,x₃,x) is defined as follows:

$$\\ \begin{matrix}H ( {x}_{0} , {x}_{1} , {x}_{2} , {x}_{3} , x ) = {[ {x}^{3} {x}^{2} x 1 ] [ \begin{matrix}{x}_{1}^{{}^{} 3} & {x}_{1}^{{}^{} 2} & {x}_{1} & 1 \\ {x}_{2}^{{}^{} 3} & {x}_{2}^{{}^{} 2} & {x}_{2} & 1 \\ 3 {x}_{1}^{{}^{} 2} & 2 {x}_{1} & 1 & 0 \\ 3 {x}_{2}^{{}^{} 2} & 2 {x}_{2} & 1 & 0\end{matrix} ]}^{- 1} [ \begin{matrix}0 & 1 & 0 & 0 \\ 0 & 0 & 1 & 0 \\ - {δ}_{1} & {δ}_{1} - {δ}_{2} & {δ}_{2} & 0 \\ 0 & - {δ}_{2} & {δ}_{2} - {δ}_{3} & {δ}_{3}\end{matrix} ] , & ( S10 )\end{matrix}$$

and where δᵢ1/2(xᵢ−xᵢ₋₁).

The function H(x₀,x₁,x₂,x₃,x) is now used to define a pre-computed matrix \hat{Ŵ} as follows. For imaging with resolution p×q and segmentation length L, the numbers uₖ (k=0, . . . L−1) are defined according to uₖ=dₐ₊ₖ (see relation (8) hereinabove) where a is the index of the first aggregate pattern deployed in the data segment and the index a +k is interpreted modulo p. Then define σ(k) is defined to be the permutation that sorts the uₖ into strictly increasing order: u_{δ(0)}< . . . <u_{σ(L-1)}. By relabeling these numbers as v₀< . . . <v_{L-1} and by making the following relations:

V₋₂=v_{L=2}−p,

v₋₁=v_{L-1}−p,

v_{L}=v₉p, and

v_{L+1}=v₁+p, . . . . (S11)

an expanded sequence is obtained satisfying v₂vᵥ₋₁<v₀<. . . <v_{L-1}<v_{L}<v_{L+1}. For any i=0, . . . , p−1, then ρ(i) is defined to be the unique integer from 0 . . . L−1 satisfying the relations as follow:

v_{ρ}(i)−1<v_{ρ(i)}≤i<v_{ρ(i)+1}<v_{ρ(i)+2}, (S12)

which is well-defined as a result of the definitions in relation (S11) hereinabove. As a result of these definitions, ρ(i) allows for the selection of appropriate data from the columns of M (stored in a permuted order from the sequencing of aggregate patterns) to implement piecewise interpolation with cyclic boundary conditions matching the indexing of Y (stored in non-permuted order).

With i fixed, four coefficients h₀, . . . , h₃ are then computed as follows:

[h₀ h₁ h₂ h₃ ]=H(v_{ρ(i)-1}, v_{ρ(i)}, v_{ρ(i)+1}, v_{ρ(i)+2}, i), (S13)

from which the ith row of Ŵ is then found as follows:

$$\\ \begin{matrix}{\hat{W}}_{i , j} = \{ \begin{matrix}{h}_{0} & if j = {σ}^{- 1} ( ρ ( i ) - 1 ) \\ {h}_{1} & if j = {σ}^{- 1} ( ρ ( i ) ) \\ {h}_{2} & if j = {σ}^{- 1} ( ρ ( i ) + 1 ) \\ {h}_{3} & if j = {σ}^{- 1} ( ρ ( i ) + 2 ) \\ 0 & otherwise\end{matrix} , & ( S14 )\end{matrix}$$

where j=0 . . . L−1, and the arguments to σ⁻¹ are each interpreted modulo L.

For any segment of scan data, the index a for the aggregate pattern corresponding to the first row of M is known at the time of reconstruction. In general, with Ŵ pre-computed and stored in memory, the matrix W used for interpolation of M depends on a as follows:

W_{i,j}=Ŵ_{i-a,j}, (S15)

where the index i−a is interpreted modulo p.

The scope of the claims should not be limited by the embodiments set forth in the examples but should be given the broadest interpretation consistent with the description.

1. A system for single-pixel imaging of an object, comprising:
a light source;
a modulator;
a polygonal mirror;
a projector; and
a detector;
wherein:
said modulator generates structured patterns from an input beam generated by said light source;
said polygonal mirror scans the structured patterns, said projector projects de-scanned structured patterns to the object; and said detector collects signals from the object; and a parallelized-processing unit is selected for reconstruction of images of the object from the signals collected by said detector.

2. The system of claim 1, wherein the modulator and the polygonal mirror are connected in a double scanning configuration.

3. The system of claim 1, wherein the modulator and the polygonal mirror are connected in a single scanning configuration.

4. The system of claim 1, wherein a scanned motion imparted by individual facets of the polygonal mirror is synchronized with updating of the structured patterns, thus generating structured patterns with each scan.

5. The system of claim 1, wherein the parallelized processing unit is selected for reconstruction of images by interpolation of scalar data distributed on a two-dimensional rectangular grid by matrix-matrix multiplication as determined by a sequence of the structured patterns generated by the modulator.

6. The system of claim 1, wherein the modulator is a digital micromirror device.

7. The system of claim 1, wherein the modulator is a digital micromirror device of a display area larger than 5 mm×5 mm, a display pixel-count larger than 10×10 pixels, and a display refresh rate larger than 6 kHz; and the polygonal mirror has a facet count larger than 4, a facet size larger I than 2 mm×2 mm, and a scan rate larger than 6 kHz.

8. The system of claim 1, wherein the modulator is a reconfigurable display.

9. The system of claim 1, wherein the modulator is a non-reconfigurable physical mask.

10. A method for single-pixel imaging of an object, comprising generating encoding patterns by illuminating a modulator with an input beam, imparting a scanned motion to the encoding patterns by a polygonal mirror, projecting de-scanned encoding patterns to the object; detecting signals from the object; and reconstructing images of the object from the signals detected from the object by parallelized-processing.

11. The method of claim 10, comprising synchronizing the scanned motion by updating of the encoding patterns generated by the modulator, thereby generating encoding patterns with each scan.

12. The method of claim 10, said parallelized-processing is selected for images acquisition by interpolation of scalar data distributed on a two-dimensional rectangular grid by matrix-matrix multiplication as determined by a sequence of the encoding patterns generated by the modulator.

13. The method of claim 10, comprising selecting a graphics processing unit for reconstruction and display of images acquired by said parallelized-processing.

14. The method of claim 10, further comprising displaying obtained reconstructed images of the object.

15. The method of claim 10, further comprising recording obtained reconstructed images of the object.

16. A method for single-pixel imaging of an object, comprising generating encoding patterns using a spatial light modulator, scanning the spatial light modulator and the encoding patterns by a polygonal mirror, projecting de-scanned encoded patterns to the object, detecting signals from the object under projection, and reconstructing images of the object from detected signals by parallelized-processing selected for images acquisition by a domain-specific matrix multiplication-based interpolation as determined by a sequence of the encoding patterns generated by the spatial light modulator.
